(19) United States
(12) Patent Application Publication
(10) Pub. No.: US 2018/0165914 A1
(43) Pub. Date: Jun. 14, 2018

(54) METHOD AND SYSTEM FOR FACILITATING THE TRANSFER OF GAME OR VIRTUAL REALITY STATE INFORMATION

(71) Applicant: INTERDIGITAL PATENT HOLDINGS, INC., Wilmington, DE (US)

(72) Inventors: Gregory S. Sternberg, Mt. Laurel, NJ (US); Shoshana Loeb, Philadelphia, PA (US); John David Doyle, Harleysville, PA (US); Kuo-Chu Lee, Princeton Junction, NJ (US); Ralph Neff, San Diego, CA (US)

(73) Assignee: INTERDIGITAL PATENT HOLDINGS, INC., Wilmington, DE (US)

(21) Appl. No.: 15/735,347

(22) PCT Filed: Jun. 23, 2016
(86) PCT No.: PCT/US2016/038928

§ 371 Date: Dec. 11, 2017

Related U.S. Application Data
(60) Provisional application No. 62/184,988, filed on Jun. 26, 2015.

(51) Int. Cl. G07F 17/32; A63F 13/87; A63F 13/352; A63F 13/493; A63F 13/795; A63F 13/86; A63F 13/31; A63F 13/335; G06Q 30/06

(52) U.S. Cl. CPC G07F 17/3227; A63F 13/87; A63F 13/352; A63F 13/493; A63F 13/795; A63F 13/86; A63F 2300/5513; A63F 13/31; A63F 13/335; G07F 17/3244; G06Q 30/0601; A63F 2300/8082; G07F 17/323

(57) ABSTRACT

A method and system for facilitating the transfer of game or virtual reality (VR) state information is disclosed herein. An Event Pattern Detection engine may receive a periodic update of a game/VR state of a Source Game/VR Client and detect a trigger for transfer of the game/VR state based on the periodic update. The Event Pattern Detection engine may then send a message for transfer of the game/VR state to a Game/VR State Transfer Engine. The Game/VR State Transfer Engine may send a request for the game/VR state to a Game/VR Server and may receive the game/VR state from the Game/VR Server. The Game/VR State Transfer Engine may send the game/VR state to a Destination Game/VR Client and receive a confirmation of the receipt of the game/VR state by the Destination Game/VR Client. The Game/VR State Transfer Engine may send a Game/VR State Transfer Complete message to the Game/VR Server.

### CROSS REFERENCE TO RELATED APPLICATIONS

This application claims the benefit of U.S. Patent Application No. 62/184,988 filed on Jun. 26, 2015, the contents of which is hereby incorporated by reference herein.

### BACKGROUND

Over the last few years, online gaming is increasingly becoming a spectator's sport. Various applications are being developed to allow spectators to follow the online games. There are even new applications that allow spectators to choose “camera” angles in the virtual game world to customize their view of the action.

In addition to the ability to follow online games in real time, spectators now are able to chat with each other on twitter or through other social chat services during the game the same way they chat about live TV events. Recent systems and methods have created shared, rich, time-shifted, connected-media experiences. The resulting system provides end users with a richer media experience that allows them to experience both the underlying media and the overlaid comments in synchronicity, thus providing greater temporal and spatial context for the comments.

### SUMMARY

The following description may include methods, systems, and apparatuses for transferring a first user's state information in an interactive gaming environment to a second user. Embodiments may include: receiving, by a state transfer engine, an automatic transfer trigger from an event pattern detection engine that is generated upon detection of predetermined parameters in one or more periodically received state updates from a game server hosting the interactive gaming environment and allowing the first user to participate and the second user to spectate using corresponding devices, wherein the state information comprises a current status of the interactive gaming environment and the first user within the interactive gaming environment; requesting, from the state transfer engine, the first user's state information from the game server; receiving, by the state transfer engine, the first user's state information; and sending, by the state transfer engine, the first user's state information to the second user, such that the second user takes over the participating at the current status of the interactive gaming environment and the first user within the interactive gaming environment.

Embodiments may include: receiving, by a state marketplace, a state offer from the first user, the state offer comprising at least a price and an identification of the first user's state information located on a game server hosting the interactive gaming environment and allowing the first user to participate and the second user to spectate using corresponding devices, wherein the state information comprises a current status of the interactive gaming environment and the first user within the interactive gaming environment; sending, by the state marketplace, a request for the first user's state information to the game server; receiving, by the state marketplace, the first user's state information from the game server; offering, by the state marketplace, the state offer to the second user; receiving, by the state marketplace, a purchase request for the state offer from the second user; and sending, by the state transfer engine, the first user's state information to the second user, such that the second user takes over the participating at the current status of the interactive gaming environment and the first user within the interactive gaming environment.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example communications system in which one or more disclosed embodiments may be implemented;

FIG. 1E is a system diagram of an example communications system in which one or more disclosed embodiments may be implemented;

FIG. 2 is a diagram of an example Portable Game Notation (PGN) file;

FIG. 3 is a diagram of an example of a game/virtual reality (game/VR) state transfer system;

FIG. 4 is a diagram illustrating a sequence of messages involved in an automatically triggered game/VR state transfer;

FIG. 5 is a diagram illustrating a sequence of messages involved in a manual push triggered game/VR state transfer;

FIG. 6A is a diagram of an example of a sequence of messages involved in a manual pull triggered game/VR state transfer;

FIG. 6B is a diagram illustrating a sequence of messages involved in a game/VR state transfer using a Game/VR State Marketplace;

FIG. 7 is a diagram illustrating a message sequence for a temporary pull game/VR state transfer (lease);

FIG. 8 is a diagram illustrating a game state transfer indicator used in an in-game environment;

FIG. 9 is a diagram illustrating a game state transfer indicator used in an in-game environment;

FIG. 10 is a diagram illustrating a game state transfer indicator used in an in-game environment;

FIG. 11 is a diagram illustrating a crowd-coach system;

FIG. 12 is a diagram illustrating a display of a recommendation in a crowd-coach system;

FIG. 13 is a diagram illustrating a functional partition for a third party game/VR state and control proxy system;

FIG. 14 is a diagram illustrating game control transfer function modules and control flow;

FIG. 15 is a component diagram of a server; and

FIG. 16 is an example computing device.

### DETAILED DESCRIPTION

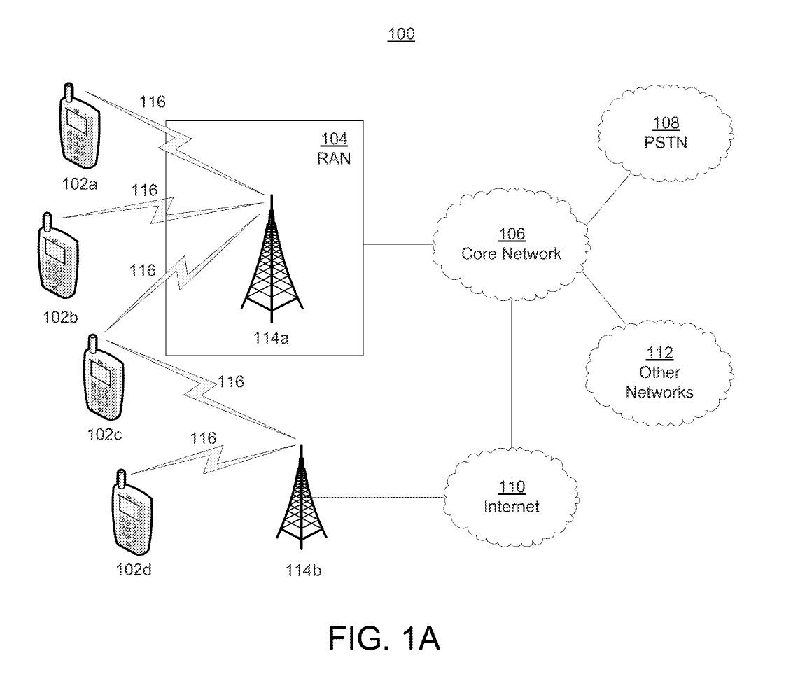

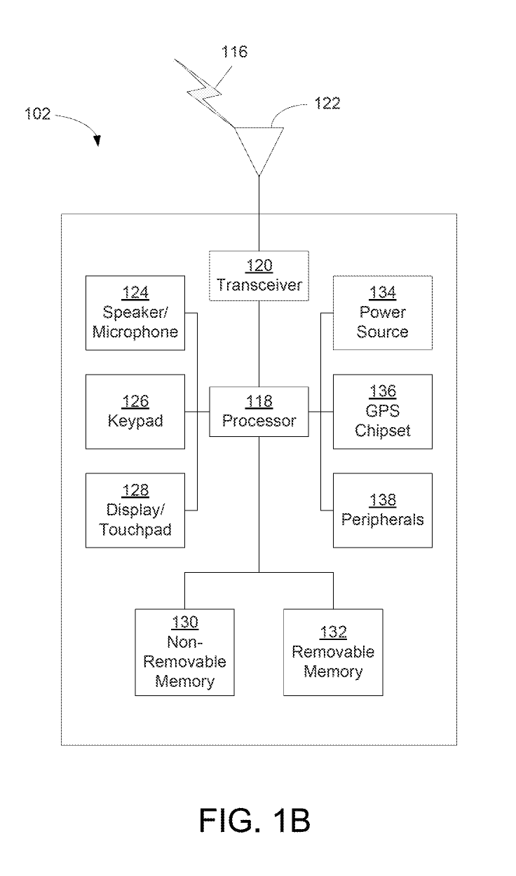

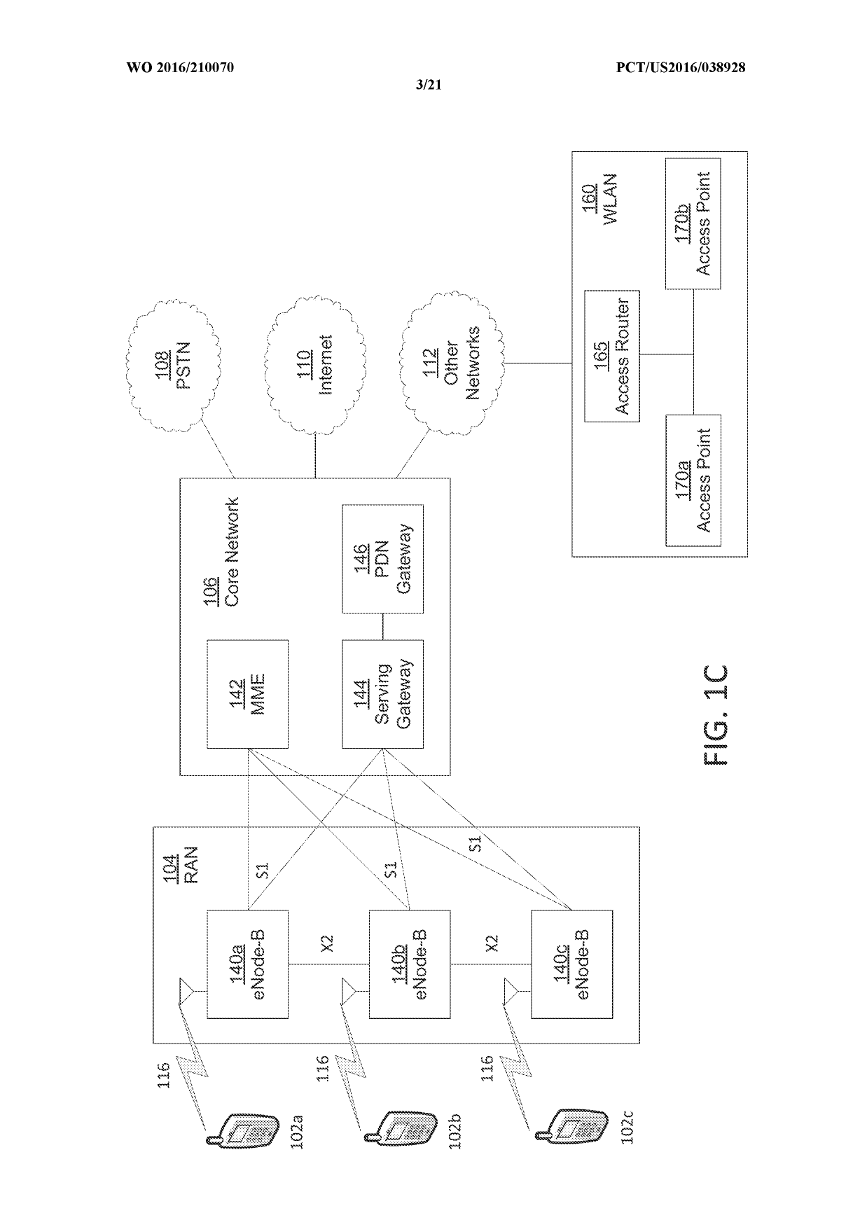

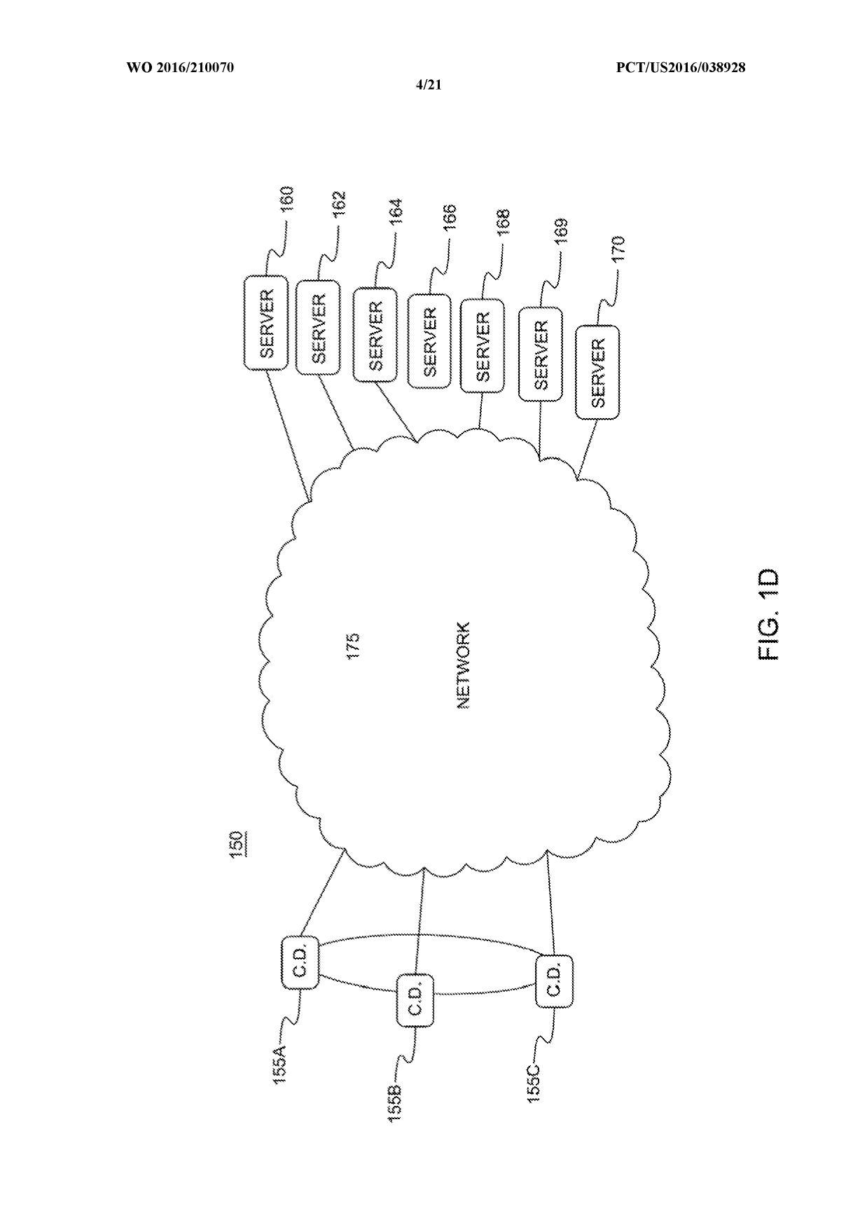

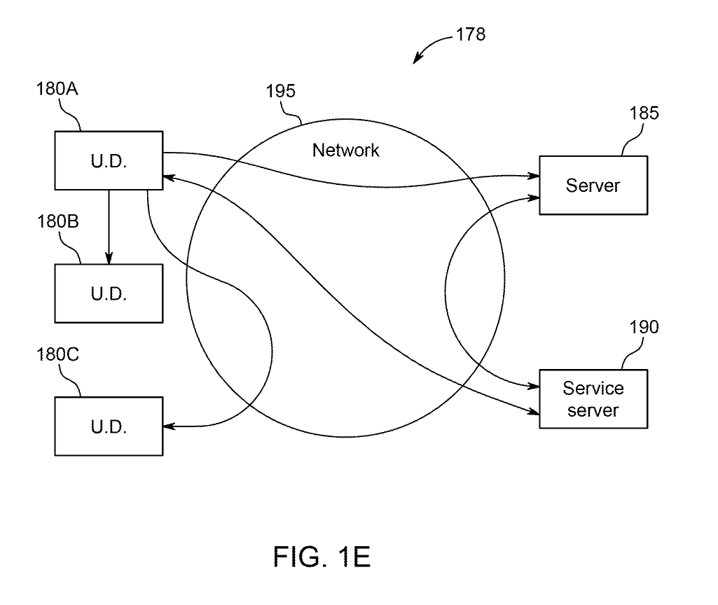

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

FIG. 1D is a system diagram of an example communications system 150 in which one or more disclosed embodiments may be implemented. In some embodiments, communications system 150 may be implemented using all or a portion of system 100 as shown and described with respect to FIG. 1A.

Computing devices 155a, 155b, 155c and servers 160, 162, 164, 166, 168, 169, 170 may communicate over communications network 175. These communications may be wireless, wired or any combination of wireless and wired. Communications network 175 may include the internet 110, core network 106, other networks 112, or any other suitable communications network or combination of communications networks.

Computing devices 155a, 155b, 155c may include a WTRU (such as WTRU 102a) or any suitable user computing and/or communications device, such as a desktop computer, web appliance, interactive television (ITV) device, gaming console (such as MICROSOFT XBOX or SONY PLAYSTATION) or the like. Computing devices 155a, 155b, 155c and/or applications executing on computing devices 155a, 155b, 155c may generate events such as mouse clicks, keyboard strokes, and the like. These events may be processed by computing devices 155a, 155b, 155c and/or may be transmitted to another device such as servers 160, 162, 164, 166, 168, 169, 170.

Servers 160, 162, 164, 166, 168, 169, 170 may include a web server, application server, data server, or any combination of these or other types of servers. Servers 160, 162, 164, 166, 168, 169, 170 may include any suitable server device such as a server computer, personal computer or the like. Servers 160, 162, 164, 166, 168, 169, 170 may host applications accessible to user devices 155a, 155b, 155c.

Computing device 155a may include a game/virtual reality (VR) client, such as a source game/VR client, which may access servers 160, 162, 164, 166, 168, 169, 170 over communications network 175 to interact with services provided by servers 160, 162, 164, 166, 168, 169, 170. Computing device 155b may include a spectator game/VR client which may also access servers 160, 162, 164, 166, 168, 169, 170 over communications network 175 to interact with services provided by servers 160, 162, 164, 166, 168, 169, 170. Further, computing device 155c may include a destination game/VR client which may also access servers 160, 162, 164, 166, 168, 169, 170 over communications network 175 to interact with services provided by servers 160, 162, 164, 166, 168, 169, 170.

Server 160 may include a game/VR server, a gaming server hosting a massively multiplayer online (MMO) game, an Augmented Reality (AR) server and/or other types of similar servers. Server 162 may include an Event Pattern Detection Engine and/or other types of similar servers. Server 164 may include a Game/VR State Transfer Engine, policy database and/or other types of similar server. Server 166 may include a state exchange entity, server hosting an over the top (OTT) application, website, marketplace and/or other types of similar servers. Server 168 may include servers hosting network game communication middleware and/or other types of similar servers. Server 169 may include a spectation system and/or other types of similar servers. Server 170 may include a second game/VR server.

Each of servers 160, 162, 164, 166, 168, 169, 170 may host the functions performed by or logical entities operating in the other servers 160, 162, 164, 166, 168, 169, 170. In some embodiments, the functions of servers 160, 162, 164, 166, 168, 169, 170 may be implemented using the same device or across a number of additional devices. Further, computing devices 155a, 155b, 155c may communicate directly with each other or through communications network 175.

FIG. 1E is a system diagram of an example communications system 178 in which one or more disclosed embodiments may be implemented. In some embodiments, communications system 178 may be implemented using all or a portion of system 100 as shown and described with respect to FIG. 1A.

User device 180a, server 185, and/or service server 190 may communicate over communications network 195. These communications may be wireless, wired, or any combination of wireless and wired. Communications network 195 may include the internet 110, core network 106, other networks 112, or any other suitable communications network or combination of communications networks.

User device 180a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 180a and/or applications executing on user device 180a may generate events such as mouse clicks, keyboard strokes, and the like. These events may be processed by user device 180a and/or may be transmitted to another device such as server 185 or service server 190.

Server 185 may include a web server, application server, data server, or any combination of these or other types of servers. Server 185 may include any suitable server device such as a server computer, personal computer, or the like. Server 185 may host applications accessible to user device 185a. For example, server 185 may include a gaming server hosting a massively multiplayer online game (MMOG), an email server, a web server hosting a website such as a social media website or blog, or other types of servers typically accessible by a user device over a computer communications network.

User device 180a may access server 185 over computer communications network 178 to interact with services that it provides. For example, user device 180a may access a game server hosted on server 185 to participate in a multiplayer online game. Access of server 185 by user device 180a may be via a client application executing on user device 180a or any other suitable mechanism. In some cases, the server 185 may receive events from user device 180a, or may send events to user device 180a. For example, the server 185 may send an event to user device 180a indicating that additional in-game resources are required for continued play.

Service server 190 may include a web server, application server, data server, or any combination of these or other types of servers hosted on a server device. Service server 190 may include any suitable server device such as a server computer, personal computer, or the like. Service server 190 may be configured to communicate with server 185, for example, over network 195 or any other suitable communications medium. Service server may be co-located with, combined with, or in direct communication with server 185.

Service server 190 may communicate with server 185 to provide services, such as third party services, to users of server 185. For example, a subscriber to a game hosted on server 185 may access server 185 from user device 180A and may subscribe to third party services for the game which are hosted on service server 190.

Service server 190 may be configured to receive and/or intercept events transmitted between user device 180a and server 185. For example, in some embodiments server 185 and service server 190 may be configured such that server 185 may send an event destined for user device 180a instead or additionally to service server 190, and service server 190 may send the event or another event, signal, or message to device 180a. For instance, in a case where server 185 includes a game server, server 185 may send an event to service server 190 indicating a requirement of a user of user device 180a, and server 190 may send the event or another signal or message to device 180a indicating that a resource is available to acquire the requirement. In some embodiments, service server 190 may forward the event to device 180a under certain conditions, such as based on a user preference and/or context information relating to the user of device 180a.

In some embodiments, the functions of service server 190 and server 185 may be implemented using the same device, or across a number of additional devices.

In some embodiments, user devices 180b and 180c may communicate with server 185 and/or service server 190 via user device 180a. For example, user device 180a may forward a notification message from service server 190 to user device 180b via a peer to peer connection and may forward a notification message from service server 190 to user device 180c via network 195. In some embodiments, user devices 180a, 180b, and 180c may form a network, such as a peer-to-peer network, and such network may have a mesh topology, a star topology using user device 180a as a coordinating node, or any other suitable topology. In such embodiments, the peer-to-peer network may operate independently of server 185 and/or service server 190, and may incorporate functionality that otherwise would be hosted by server 185 and/or service server 190, such as functionality described herein.

In conventional systems, spectators may be able to communicate with individual online game players. The game players can filter and select which messages they would like to receive and when. This filtering of incoming messages is based on various attributes such as the sender of the message, the content of the message, as well as the content and state of the player in the game (e.g., busy, needs help, would like to chat). The system also allows for looking at the commentaries off-line and as part of watching the game in re-played mode.

Media Mobility has been actively developed in which multimedia can be “handed-off” between devices, for example, a video being watched on a Smart Phone can be continued on a TV.

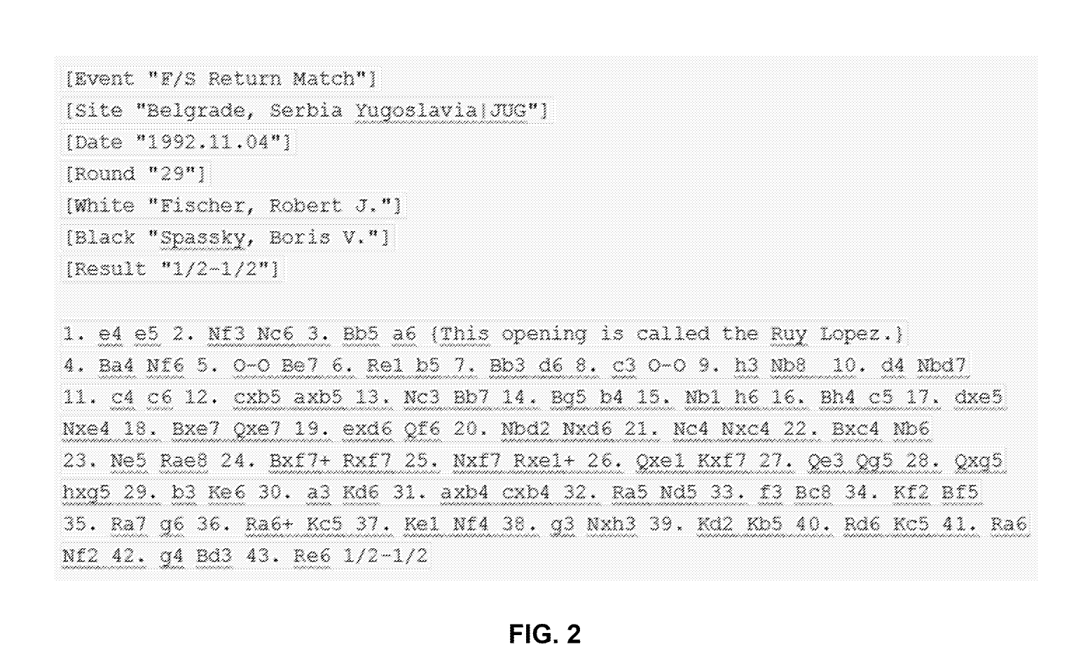

Conventional transfer of a user's session in simple gaming environments, such as an electronic game of chess, may be done using a Portable Game Notation (PGN) file. Chess state transfer may be performed by exporting the state of a user during the game into a PGN file. PGN is a plain text computer-readable format for recording chess games (both the moves and related data), supported by many chess programs. FIG. 2 is a diagram of an example Portable Game Notation (PGN) file.

Conventional systems may enable automatic monitoring of aspects of users' behavior based on previously discovered patterns, correlated with quality of users' experience. Specifically, a real-time Event Pattern Detection Engine may be used for the detection of patterns of interest and for issuing appropriate pre-defined alerts and remedial actions. The detected events can come from a variety of data sources including game events generated by the user and events indicating network impairment. The patterns may also take into account user profile attributes such as frequency of participation, length of participation and other relevant attributes. One of the triggered actions can be a personalized tutorial based on the users' state and profile.

Gaming and VR systems may allow for remote viewing from the perspective of other users. Disclosed herein are mechanisms integrated into a gaming environment, such as a gaming system, to facilitate the transfer of game/VR state between users.

Systems and methods are disclosed herein for initiating and executing the exchange of game/VR state information in concert with game/VR multimedia. The methods described include both real-time game and real-time VII state transfer (both temporary and persistent), cloning, both push and pull triggers, automated triggering based on a configured policy, virtual and manual coaching, crowdsourced coaching/game play, as well as offline game/VR state transactions.

As used herein, game state may be defined as the information about the current status of a specific game, or avatar within a game, that is associated with a user's game account. This game state information may enable a user to return, following a disruption in the real-time game environment, to an exact location, or to an appropriate re-start point, within the game environment and with exactly the same attributes and history of in-game accomplishments as before the disruption. Game state information to enable this feature includes but is not limited to current character profile and configuration settings, inventory, current location and orientation, quest status, achievements and affiliations, and state transfer history and availability.

As used herein, VR state may be defined as information about the current status of a VR environment such that the environment can be repeated or recreated (e.g., exactly recreated) for the source user following a disruption, and for transfer or cloning of the VR environment for destination users. VR state information to enable this feature includes but is not limited to user profiles and configuration settings, location and orientation, available applications, and state transfer history and availability. VR state information may be stored in, maintained by, or used by any of a VR display apparatus (e.g., a set of VR goggles worn by a user or other suitable VR display device), a mobile device in communication with a VR apparatus, or a cloud based service.

As used herein, VR state may in some embodiments take the form of an AR state. For example, it may be the state of an AR application or an AR experience of a user. Transfer of an AR state may allow the AR environment currently experienced by a first user to be transferred to or recreated for a second user. Each user may view the AR application or AR experience using an AR display apparatus (e.g. a set of AR goggles worn by the user, or other suitable AR display device). The AR state information may be stored in, maintained by, or used by any of an AR display apparatus, a mobile device in communication with the AR apparatus, or a cloud based service.

As used herein, game/VR state may be used to represent an environment which can be a game state, a VR state, an AR state, or a combination of such states.

Methods and systems disclosed herein have several embodiments, including at least, but not limited to, the following: real-time game/VR state transfer, temporary real-time game/VR state transfer/cloning (lease), real-time game/VR state cloning, “instanced” game/VR state, game/VR state transfer or cloning indicators, offline game state delivery, virtual coaching, manual coaching, coaching ratings, recognition of coaching skills through achievements, trophies, etc., crowdsourced coaching/game play, game/VR transfer policy restrictions, partial game/VR state transfer and proxy for over the top transfer. These embodiments may be described in more detail below.

The following description may include real-time game/VR state transfer. The real-time game/VR state transfer may be initiated by either a push or a pull trigger. For example, in a pull transaction, an expert player may allow his/her game state to be transferred in return for compensation. The compensation may be in the form of in-game assets, hard currency or some other form of remuneration. Alternatively, in a push triggered exchange, a gamer may need help with a certain portion of the game and initiate a request for help such that a spectator could take over control of the gameplay in response to the request for help.

The availability of a game/VR state for exchange (e.g., transfer or clone) may be indicated within the game/VR environment or associated information panels. The state availability indicator may be graphical (e.g., flags, symbols, special effects and the like) or text based (e.g., “Is Available For Exchange? Yes/No”). If state exchange is possible but not directly enabled by the game/VR software, then an over-the-top (OTT) application or website, or a combination of these, may be utilized to indicate state exchange availability, to execute the state exchange, or some combination of these features. The OTT application or website could take the form of a marketplace for game/VR state objects, for example.

The ability for a potential destination user to request an exchange to obtain another user's game/VR state may be built into the game/VR software, hardware, official website, independent licensed websites, or some combination of these. In addition to this functionality, additional functionality may be added to enable any inquiry, bartering (where applicable) and/or agreement among involved parties as well as enabling the actual state exchange.

The pricing for a game/VR state exchange may be set by the parties involved in the state exchange, including but not limited to the game/VR developers, game/VR producers, game/VR network providers, OTT application developers, affiliated or independent State Exchange websites, source users, or some combination of these. In addition to possible remuneration for the source user, additional fees may be added by the aforementioned parties involved in the state exchange. All costs may be detailed with the State Exchange Availability information. Remuneration for the source users and other stakeholders can be implemented within the game/VR environment (e.g., in-game assets, subscription extensions) or outside the game/VR environment (e.g., credit, PayPal, check, bank transfer) or some combination of these implementations.

The state exchange entity (e.g., OTT application, website, and/or marketplace) may be: built into the game/VR software; built into the game/VR hardware; provided via one or more websites or OTT applications maintained by the game/VR developers, game/VR producers, game/VR network providers, licensed independent business partners, or some combination of these; and/or provided by a third party which may or may not have a business relationship with the game/VR developers or producers.

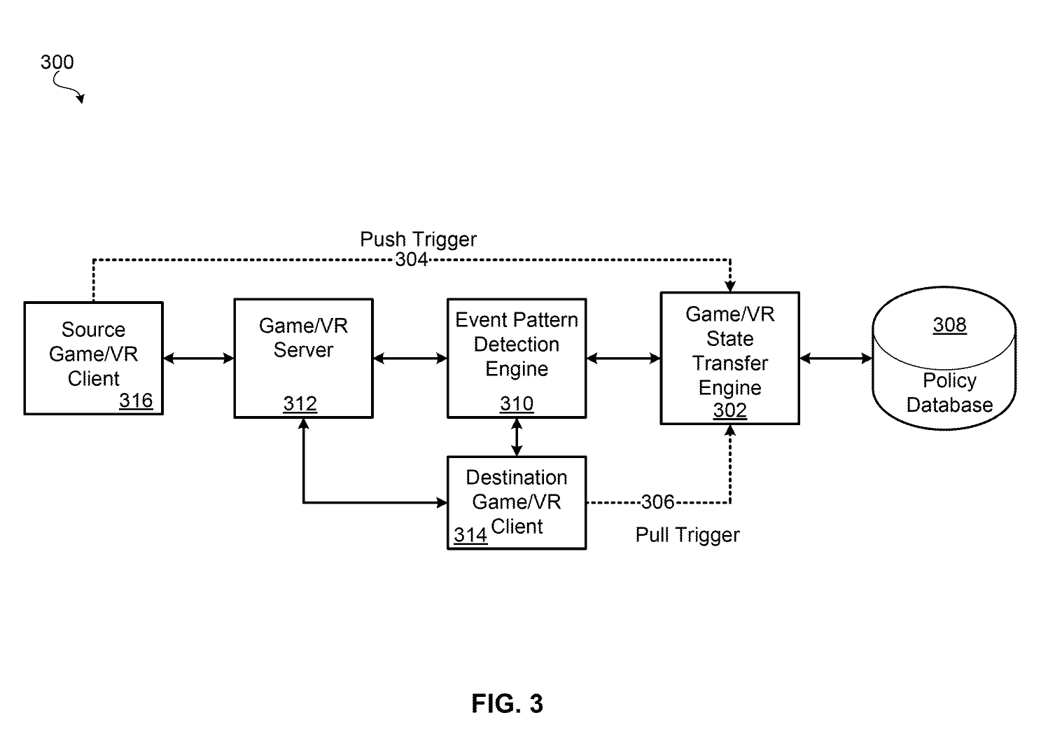

FIG. 3 is a diagram of an example of a game/VR state transfer system 300. FIG. 3 depicts an example of the relationships and communications between the elements of the overall system architecture.

In order to utilize the exchanged game/VR state, a Destination Game/VR Client 314 may: have access to the State Exchange marketplace; have access to the hardware required to support the exchanged game/VR state; and have access to the software required to interact with the exchanged game/VR state, or may be provided the opportunity to procure the required software, either as part of the state exchange or as a separate transaction with the appropriate party or parties.

Additionally, automated triggering may be enabled based on a predefined policy that would be responsive to gamer/user performance, network conditions, in-game/VR environmental conditions, and the like. A Game/VR State Transfer Engine 302 may take inputs from an Event Pattern Detection Engine 310 which provides alerts regarding the status of the gameplay, network and impairments, or it may take state input directly from a Game/VR Server 312 and identify the salient features necessary to automatically trigger a transfer of game/VR state.

The specification of a game state may entail specifying several information elements that may include, but are not limited to, one or more of: a game identifier (ID), a session ID, a task ID, a game artificial intelligence (AI) opponent, a role of an avatar, a player action, as well as points of interest that define the game states in which the state transfers may take place. Game state information elements may also include, but are not limited to, one or more character properties such as a character type, an experience level, tasks achieved, an inventory of objects owned, points accumulated, character health (e.g., “health points”), amount of money or gold owned by the character, an energy level, skills attained, spells or special moves learned, and the like. These various information elements may be reassigned to the new user when a game state transfer takes place.

The game transfer trigger mechanism may include a set of rules (e.g., patterns of events that comprise the rule's IF part and a triggered action that comprise the THEN part) to detect the conditions on when to transfer based on the game state. The event pattern detection rules may support the event pattern detection on multiple combinations of game state patterns. For example, one of the rules may detect the pattern that the player has failed many times in the same point of the game (e.g., cannot pass a race track or kill a monster). A second rule or another pattern of the same rule may detect the pattern that the current player's action is suitable to start the transfer (e.g., player just failed or is not in the middle of fighting or running away from opponents). When both event patterns are detected, a game transfer trigger event may be generated.

The Destination Game/VR Client 314 to transfer the game to may be selected by the player or by the system from a set of players who have passed the same game task (e.g., run a race track or kill a monster). Another set of rules may detect patterns from the selected players and decide when to invite the player to accept the game transfer. This set of the rules may check criteria such as player's skill level and availability.

In an example, the policy in the Game/VR State Transfer Engine 302 may either automatically trigger a transfer of game/VR state or may simply trigger the suggestion to the current player that a transfer of game/VR state is recommended based on performance. The functionality performed in the Game/VR State Transfer Engine 302 may be performed in a server for the Game/VR State Transfer Engine 302, the Event Pattern Detection Engine system 310 or directly in the game/VR server 312.

In an example, the policy enforced by the Game/VR State Transfer Engine 302 may allow transfers or clones in accordance with the terms dictated by the policy. For example, policy may permit the transfer of game/VR state once or some other fixed number of times, or may limit the number of transfers in a time period, as described further herein. Policy may dictate that the transfer of game/VR state be made to users with a certain rating/ranking. In an example, while the policy may remain flexible on these characteristics, a specific transaction may limit the terms of the transfer of game/VR state. For example, one user may be willing to transfer their game/VR state subject with the limitation that it never be transferred again. The nature of these transaction terms may influence the value of the game/VR state and may thus be disclosed prior to completion of the transaction.

The Game/VR Transfer Engine 302 may also be monitoring for indications of fraud and/or misuse. For example, while policy may allow for the transfer of a game/VR state for an arbitrary number of times, very frequent game/VR state transfer may be an indication of exploitation or abuse, and actions may be taken to halt additional transfers. These mechanisms may be dictated by policy and may be enforced by the Game/VR State Transfer Engine 302.

The context switch for the game/VR state transfer may require temporarily suspending gameplay to avoid ambiguities and prevent disruption of the game play during the handoff. In an example, turn based games may more naturally allow for a context switch from one player to another without the need for explicit suspension of gameplay. Countdown timers may be used on both the source and destination devices indicating when the state transfer will become effective and control may be relinquished by the source user and given to the destination user. Alternatively, in lieu of a countdown timer, specific criteria or completion of a task/level may be the trigger to transfer control.

The exchange may be brokered by the Game/VR State Transfer Engine 302, by a third party, by the game/VR service provider, or may be negotiated directly between the parties, such as a Source Game/VR Client 316 and the Destination Game/VR Client 314. The exchange may take place via a website or an application (e.g., an OTT application) which facilitates the transfer of game/VR state. The website or application may be in the form of a marketplace, for example. Various auction techniques may be utilized to affect the exchange. In the case of a push trigger (e.g., push transaction) 304, users may offer (e.g., ask for a certain fee) to take the state and further the progress in the game/VR environment. In the case of a pull trigger (e.g., pull transaction) 306, users may bid (e.g., offer to pay) in order to obtain the game/VR state such that they can begin progressing from that point in time. Also, the trigger may be an automatic trigger.

A policy database 308 may contain automatic triggers (e.g., code, logic, or descriptions of triggering patterns). The policy database 308 may contain additional policies (e.g., policy logic or descriptions) to describe, specify or constrain the circumstances under which a transfer will take place, or under which a transfer may be permitted to take place. The policy database 308 may contain policies which describe which types of state/VR transfer (e.g., push, pull, sale, lease, partial, etc.) may be allowable under certain circumstances. The policy database 308 may contain policies which specify which users or which types of user are eligible for state/VR transfers, or for certain types of state/VR transfers.

Regardless of how the game/VR state transfer is brokered, the Game/VR State Transfer Engine 302 may process the transaction. At the source user's preference and where allowed by a game/VR server policy, the source user may receive compensation either in the in-game/VR environment or outside of the game/VR environment, or both, or neither, if allowed by a game/VR server and/or Game/VR State Transfer Engine 302 policies, for permanent and/or temporary game/VR state transfers. Such transactions may be performed for a fee (e.g., in-game currency or hard currency) charged to the source user, to the destination user, to OTT services associated with the account, or to all involved parties in the transaction, in order to generate revenue for the game developers, producers and game network providers (e.g., Xbox Live, PlayStation Network). Such fees may be established by the game developers, producers and/or game network providers and can be structured as a set fee per transaction, on a sliding scale based on exclusivity or other factors for game/VR state transfers and clones, or on some other basis. Further, the fee may be based on inclusion or exclusion of game/VR avatar/account assets (e.g., objects owned or gold/money accumulated), achievements, ranking/ratings, and other content associated with the in-game/VR account as well as additional fees for social network connections, accounts, and content associated with the account/avatar involved in the transaction. Such fees may be applied to permanent game/VR state transfers and/or to temporary game/VR state transfers (e.g., cloning, manual coaching, etc.).

In an example, following the case of a game/VR state transfer, the source user may no longer have access to the game state and may in this case no longer be able to continue progressing from that point. There may be exceptions to this, for example a coaching relationship may be set up between the source and destination user, as described herein. The source user may be able to continue to monitor the progress of the game/VR state as a spectator or as a manual coach.

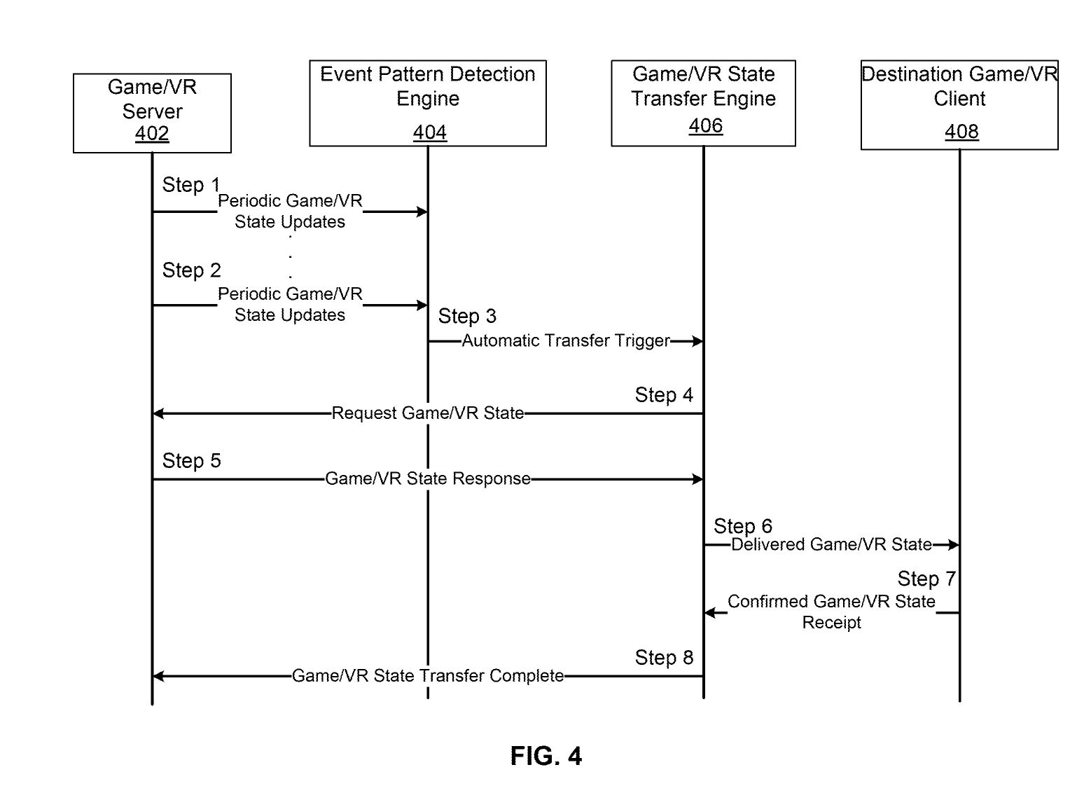

FIG. 4 is a diagram illustrating a sequence of messages involved in an automatically triggered game/VR state transfer. In this flow, in Step 1 and Step 2, the game/VR server 402 may send periodic updates of the game/VR state to the Event Pattern Detection Engine 404. The Event Pattern Detection Engine 404 may detect a trigger for state transfer (for example, it may detect that a particular user is repeatedly failing to complete a current level or task). In Step 3, once a trigger occurs, the Event Pattern Detection Engine 404 may send a message to the Game/VR State Transfer Engine 406. In Step 4, the Game/VR State Transfer Engine 406 may then send a request for game/VR State to the Game/VR Server 402. In Step 5, the Game/VR Server 402 may respond with the current game/VR State. In Step 6, the Game/VR State Transfer Engine 406 may then deliver the game/VR state to the Spectator Game/VR Client 408, which may be the destination client. Finally, in Step 7 and Step 8, the Spectator Game/VR Client 408 may confirm receipt of the state to the Game/VR State Transfer Engine 406 which in turn may inform the Game/VR Server 402.

Although not shown in FIG. 4, the Game/VR Server 402 and/or the Game/VR State Transfer Engine 406 may communicate with a Source Game/VR Client (e.g., the original owner of the transferred state) in order to inform the Source Game/VR Client of the impending state transfer or of the successful completion of the state transfer, or to seek permission from the Source Game/VR Client for the transfer to occur.

In other variations of the automatically triggered transfer of FIG. 4, the game/VR state may travel different paths during the transfer. For example, the game/VR state may be transferred (e.g., by the Game/VR Server 402 and/or the Game/VR State Transfer Engine 406) to a second Game/VR Server (not shown) which may serve the destination Game/VR Client 408. In this way, the destination Game/VR Client 408 may play the game using the second Game/VR Server which has received the transferred state object, and the second Game/VR Server may associate the received state object (e.g., may associate ownership of the received state object) with the destination Game/VR Client 408. In yet another example, the Game/VR Server 402 may transfer ownership of the game/VR State within the Game/VR Server 402 in response to an automatically determined transfer trigger. In this case, the Game/VR Server 402 may effectively transfer ownership of the game/VR State to a destination Game/VR client 408, even if the game/VR state does not travel outside of the Game/VR Server 402.

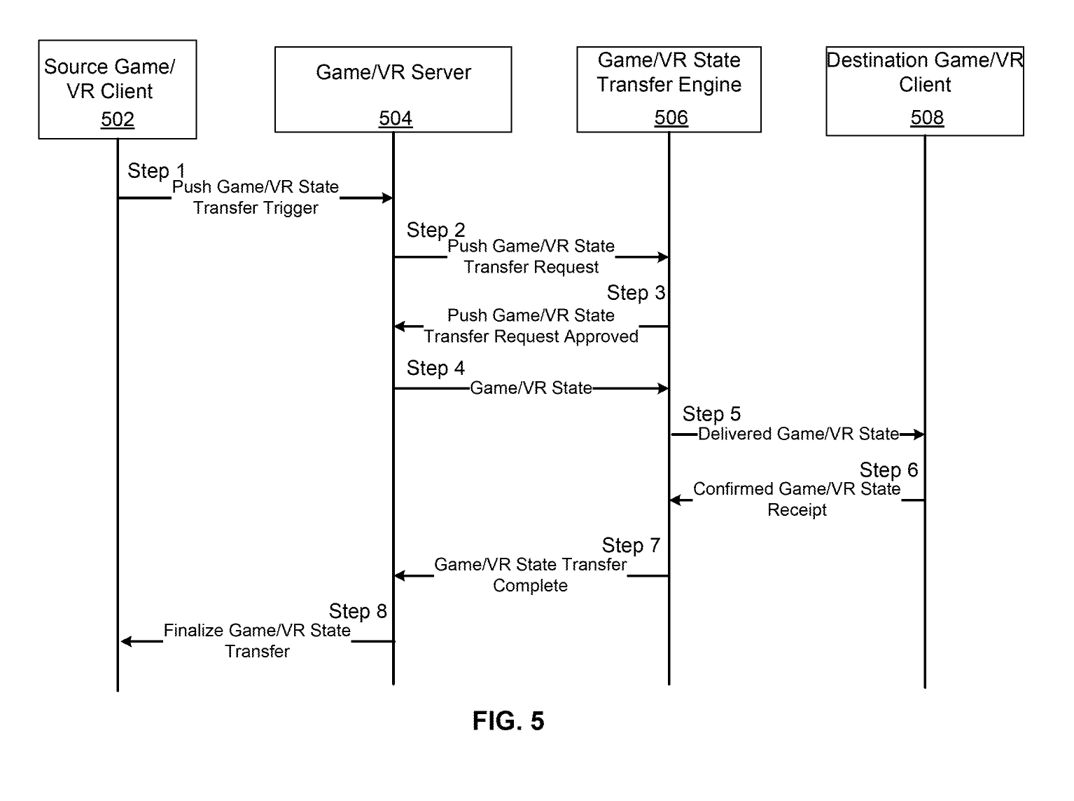

FIG. 5 is a diagram illustrating a sequence of messages involved in a manual push triggered game/VR state transfer. In Step 1, in response to a user request, a Source Game/VR Client 502 may send a Game/VR State Transfer Trigger message to a Game/VR Server 504. In Step 2, the Game/VR Server 504 may send a Push Game/VR State Transfer Request message to a Game/VR State Transfer Engine 506, which, in Step 3, may respond with a Push Game/VR State Transfer Request Approved message. In Step 4, the Game/VR Server 504 may then send a message with the game/VR state to the Game/VR State Transfer Engine 506. In Step 5, the Game/VR State Transfer Engine 506 may then send the state to the Spectator/Destination Game/VR Client 508 in a Delivered Game/VR State message. In Step 6, the Spectator/Destination Game/VR Client 508 may then respond to the Game/VR State Transfer Engine 506 with a Confirmed Game/VR State Receipt message which may be forwarded to the Game/VR Server 504 (as a Game/VR State Transfer Complete message) in Step 7. In Step 8, the Game/VR State Transfer Complete message may be sent to the Source Game/VR Client 502 (as a Finalize Game/VR State Transfer message).

In another example of the push transfer of FIG. 5, the Source Game/VR Client 502 may interact directly with the Game/VR State Transfer Engine 506 in order to request the transfer. For example, the Source Game/VR Client 502 may send the Push Game/VR State Transfer Trigger directly to the Game/VR State Transfer Engine 506, which may then interact with the Game/VR Server 504 to request and retrieve the game/VR state and to deliver the game/VR state to the Destination Game/VR Client 508. The trigger may include an identifier for the state object and/or authorization information for the transfer and the Game/VR State Transfer Engine 506 may use this information to request the game/VR state from the Game/VR Server 504.

In other examples of the push transfer of FIG. 5, the game/VR state may travel different paths during the transfer. For example, the game/VR state may originate at the Source Game/VR Client 502, which may provide the game/VR state (e.g., a state object) to the Game/VR State Transfer Engine 506 in order to facilitate the transfer. In another example, the game/VR state may be transferred (e.g., by the Game/VR Server 504 and/or the Game/VR State Transfer Engine 506) to a second Game/VR Server (not shown) which may serve the Destination Game/VR Client 508. In this way, the Destination Game/VR Client 508 may play the game using the second Game/VR Server which has received the transferred state object, and the second Game/VR Server may associate the received state object (e.g. may associate ownership of the received state object) with the Destination Game/VR Client 508. In yet another example, the Game/VR Server 504 may transfer ownership of the game/VR state within the Game/VR Server 504 in response to a push transfer trigger. In this case, the Source Game/VR Client 502 and a Destination Game/VR Client 508 which are both served by the Game/VR Server 504 may effectively transfer ownership of the game/VR state, even if the game/VR state does not travel outside of the Game/VR Server 504.

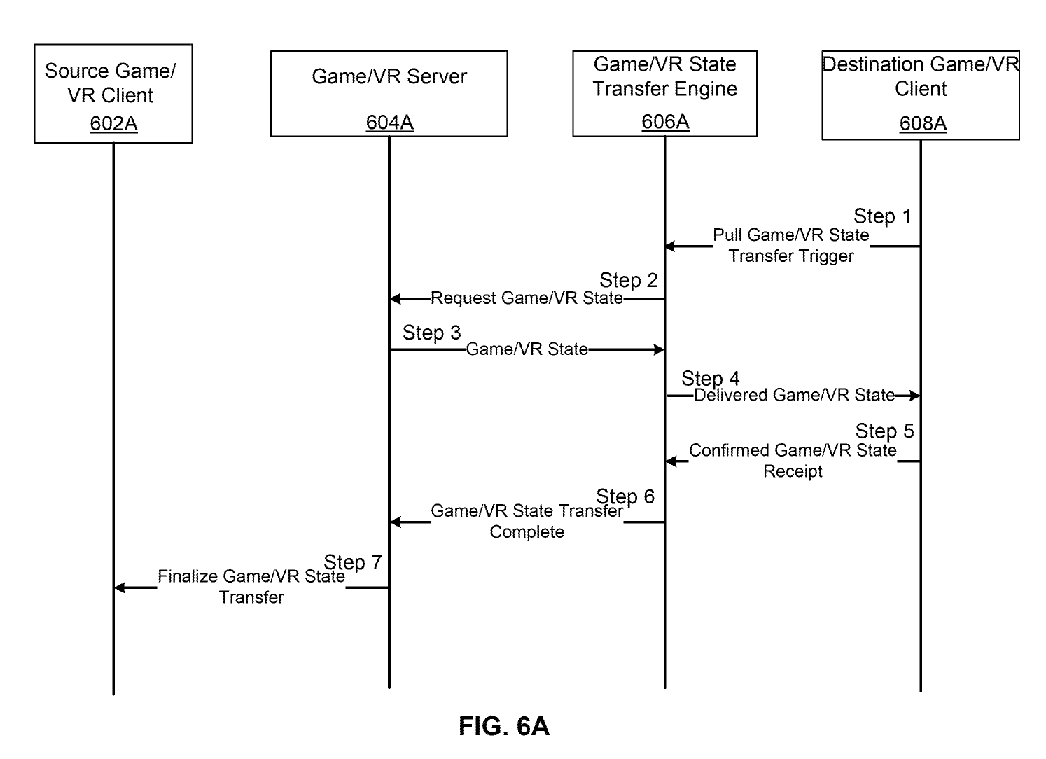

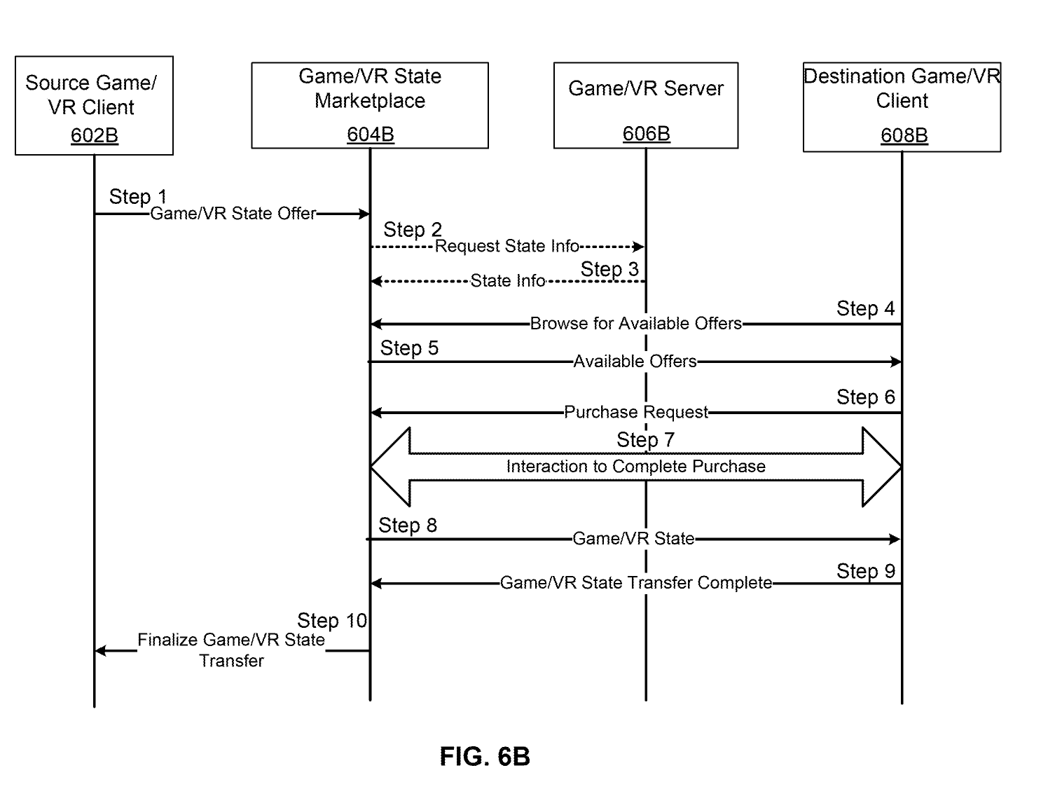

FIG. 6A is a diagram of an example of a sequence of messages involved in a manual pull triggered game/VR state transfer. In an example, in Step 1, a Spectator Game/VR Client 608A may send a Pull Game/VR State Transfer Trigger message to a Game/VR State Transfer Engine 606A in response to a user request (e.g., a request by a user of the Spectator Game/VR Client 608A). In Step 2, the Game/VR State Transfer Engine 606A then may send a Request Game/VR State message to a Game/VR Server 604A. In Step 3, the Game/VR Server 604A may respond with a game/VR state message containing the current state. In Step 4, the Game/VR State Transfer Engine 606A may send a Delivered Game/VR State message to the Spectator Game/VR Client 608A containing the game/VR state. In Step 5, the Spectator Game/VR Client 608A may respond with a Confirmed Game/VR State Receipt message. In Step 6 and Step 7, the Game/VR State Transfer Engine 606A may send a Game/VR State Transfer Complete message to the Game/VR Server 604A which in turn may send a Finalize Game/VR State Transfer message to the Source Game/VR Client 602A.

In another example of the pull transfer of FIG. 6A, the Game/VR State Transfer Engine 606A may have additional interactions with the Source Game/VR Client 602A. For example, after the Game/VR State Transfer Engine 606A receives the Pull Game/VR State Transfer Trigger message from the Spectator Game/VR Client 608A, the Game/VR State Transfer Engine 606A may send a message to the Source Game/VR Client 602A (either directly, or via the Game/VR Server 604A) in order to inform the Source Game/VR Client 602A of the intended state transfer, or to seek permission to perform the state transfer. The Source Game/VR Client 602A may, in some cases, respond with a message to the Game VR/State Transfer Engine 606A (either directly or via the Game/VR Server 604A) in order to grant or to deny permission for the transfer.

In other examples of the pull transfer of FIG. 6A, the game/VR state may travel different paths during the transfer. For example, the game/VR state may originate at the Source Game/VR Client 602A, which may provide the game/VR state (e.g., a state object) to the Game/VR State Transfer Engine 606A (e.g., in response to a request for the game/VR state sent from the Game/VR State Transfer Engine 606A or from the Game/VR Server 604A) in order to facilitate the transfer. In another example, the game/VR state may be transferred (e.g., by the Game/VR Server 604A and/or the Game/VR State Transfer Engine 606A) to a second Game/VR Server (not shown) which may serve the Destination Game/VR Client 608A. In this way, the Destination Game/VR Client 608A may play the game using the second Game/VR Server which has received the transferred state object. The second Game/VR Server may associate the received state object (e.g., may associate ownership of the received state object) with the Destination Game/VR Client 608A. In yet another example, the Game/VR Server 604A may transfer ownership of the game/VR state within the Game/VR Server 604A in response to a pull transfer trigger. In this case, the Source Game/VR Client 602A and the Destination Game/VR Client 608A, which are both served by the Game/VR Server 604A, may effectively transfer ownership of the game/VR state, even if the game/VR state does not travel outside of the Game/VR Server 604A.

In FIGS. 4-6A, the logical entities of the Game/VR server (402, 504, 604A), the Game/VR State Transfer Engine (406, 506, 606A), and the Event Pattern Detection Engine (404) may be grouped in various ways. For example, the Game/VR State Transfer Engine (406, 506, 606A) could be combined with the Game/VR Server (402, 504, 604A) in that both could be operated by the same party, be located at the same physical location, or even be resident in the same physical server. As another example, the Game/VR State Transfer Engine (406, 506, 606A) could be separated from the Game/VR Server (402, 504, 604A) in that these components could be operated by different parties, could reside on different physical servers, could be located at different physical locations, and the like. In each case, the Event Pattern Detection Engine (404) could be a separate component, or it could be combined (e.g., at same location or in same physical server) with either or both of the Game/VR State Transfer Engine (406, 506, 606A) and the Game/VR Server (402, 504, 604A)

FIG. 6B is a diagram illustrating a sequence of messages involved in a game/VR state transfer using a Game/VR State Marketplace. As shown in FIG. 6B, a game/VR state may be offered by a Source Game/VR Client 602B via a Game/VR State Marketplace 604B. The Game/VR State Marketplace 604B may operate as a service which may allow some game/VR clients to offer game/VR state objects for sale or lease, and may allow other game/VR clients to discover or browse for such game/VR state objects, and to select such objects for purchase. The Game/VR State Marketplace 604B may have the functionality previously described of a Game/VR State Transfer Engine (406, 506, 606A). For example, the Game/VR State Marketplace 604B may receive the game/VR state object (e.g., from the Source Game/VR Client 602B, or from a Game/VR Server 606B), and it may deliver the game/VR state object to the Spectator/Destination Game/VR Client 608B when a purchase is completed.

As shown in FIG. 6B, in Step 1, a Source Game/VR Client 602B may send a Game/VR State Offer to the Game/VR State Marketplace 640B. The offer may include the actual Game/VR State Object (if the client has access to the object). The offer may include an identifier for the Game/VR State Object so that the Game/VR State Marketplace 604B may retrieve information about the Game/VR State Object (and/or may retrieve the Game/VR State Object itself) from the Game/VR Server 606B. The offer may include an identifier (e.g., a URL or other identifier) of a Game/VR Server 606B from which the Game/VR State Object or information about the Game/VR State Object may be retrieved. The offer may include metadata describing the Game/VR State Object (e.g., may identify the game, the current level, the avatar name, the user's level of experience, significant items possessed or owned by the user, etc.). The offer may additionally identify the Source Game/VR Client 602B or a user of the client, and it may indicate a price at which the Game/VR State Object should be sold. In an example, the Game/VR State Marketplace 604B may be an application, an OTT application, a web application, or a web site.

In Step 2 and Step 3, the Game/VR State Marketplace 604B may contact the Game/VR Server 606B to request/obtain the Game/VR State Object and/or metadata describing the Game/VR State Object. In an example, the Game/VR State Marketplace 604B may receive metadata about the Game/VR State Object, or it may derive metadata from the Game/VR State Object itself. In either case, the Game/VR State Marketplace 604B may analyze and format the metadata to form a description of the Game/VR State Object for display and advertisement to potential buyers. The description, including pricing, may be displayed to users or clients browsing for game/VR state objects.

In Step 4, a Destination Game/VR Client 608B may browse the Game/VR State Marketplace 604B for available offers. Such browsing may be general (e.g., browse pages of available Game/VR State Objects as arranged by the Game/VR State Marketplace 604B, which may be listed by specific game, by experience level, by price, or any of the other metadata parameters available to the marketplace), or it may allow a user to set query terms (e.g., looking for states for a particular game, a particular experience level, or a character possessing a particular magical object, etc.). In Step 5, the Game/VR State Marketplace 604B may respond by returning the available offers which match any provided query criteria. The available offers may be formatted as a web page, for example.

In Step 6, the Destination Game/VR Client 608B may select the Game/VR State Object (e.g., the object offered originally by the Source Game/VR Client 602B) for purchase. Selection may be indicated in a Hypertext Transfer Protocol (HTTP) request, or in an application-specific protocol message, for example. In Step 7, the Destination Game/VR Client 608B may interact with the Game/VR State Marketplace 604B to complete the purchase (e.g., may enter user account information, supply credit card or banking information if not already associated with the user's account, authorize the purchase, etc.).

In Step 8, once the purchase is completed, the Game/VR State Marketplace 604B may deliver the Game/VR State Object to the Destination Game/VR Client 608B, and may contact the Source Game/VR Client 602B to finalize the purchase (e.g., to notify the source client that the purchase is complete, and to provide the source client with an account update/payment information). In an embodiment, the Game/VR State Marketplace 604B may collect a commission when a game/VR state object is sold. For example, the marketplace may transfer 90% of the purchase price to the Source Game/VR Client 602B (e.g., to a user of the Source Game/VR Client 602B) and the Game/VR State Marketplace 604B may retain 10% of the purchase price as a commission for facilitating the transfer.

In an embodiment, the Game/VR State Marketplace 604B may be connected to multiple different game/VR servers in order to obtain game/VR state objects for multiple different games or VR applications. In this case, the Game/VR State Marketplace 604B may present a generic application programming interface (API) by which any game/VR server may provide generic metadata useful to the display, sorting, advertising and sale of game/VR state objects for various games and/or VR applications. The API may define common classes of games (e.g., first person shooter, adventure, cards, strategy, tower defense, etc.) and may also define properties common to the state objects of many games (e.g., game world, game level, experience level, objects owned, character class, etc.).

An extension mechanism may be defined so that a game/VR server may define custom property names, and in this way may provide properties of a game/VR state which are not included in the common properties defined by the API. The game/VR server may provide metadata properties (whether common properties or custom properties) using a name plus value (name+value) format, for example. In this way, the Game/VR State Marketplace 604B may obtain descriptive metadata about different games or VR applications from various game/VR servers without the marketplace needing to parse and understand such metadata from the game/VR state objects themselves. The game/VR state server may also provide the game/VR state object to the Game/VR State Marketplace 604B for delivery as a generic game/VR state object payload, so that the Game/VR State Marketplace 604B may deliver the state object to a destination client regardless of whether the Game/VR State Marketplace 604B itself is capable of parsing the game/VR state object for the various different games.

In an embodiment, the Game/VR State Marketplace 604B may have additional interaction with a source game/VR state client in order to set or determine the price at which the game/VR state object should be sold. For example, the Game/VR State Marketplace 604B may have logic to determine a suitable price for a game/VR state object based on experience level, skills attained, game levels completed, tasks completed, or other properties of the game/VR state object. The price may be a pre-defined function of such properties, or it may be computed based on historical sales of similar game/VR state objects (e.g., under auction or other negotiated sales). Subsequent to the initial offer by the source game/VR client, the Game/VR State Marketplace 604B may compute an asking price for the game/VR state object and may communicate this price in a message to the source game/VR client. The source game/VR client may accept the price, or may rescind/cancel the offer for sale.

In an embodiment, when a source game/VR client offers a game/VR state object for transfer (e.g., for sale to the Game/VR State Marketplace 604B), the source game/VR client (or the source user) may give up the right to use the game/VR state object pending the sale. Such a usage restriction may be enforced by software on the client, for example (e.g., in response to user input which indicates that a game/VR state object should be offered for sale). Usage of the game/VR state object may be restored to the source game/VR client (or the source user) if the sale transaction is canceled or rescinded.

In another embodiment, when a source game/VR client offers a game/VR state object for transfer (e.g., for sale to the Game/VR State Marketplace 604B), the source game/VR client may retain use of the game/VR state object until the sale is completed. In this case, the source game/VR client may send periodic updates of the game/VR state object and/or associated metadata, or the Game/VR State Marketplace 604B may periodically request such updates from an associated game/VR server. For example, the updates of the game/VR state object may reflect the evolution of the game/VR state object as the source game/VR client continues to play the game. The Game/VR State Marketplace 604B may then display the updated metadata to users browsing for game/VR state objects, may use the updated metadata to classify or sort the game/VR state object, may use the updated metadata to respond to queries from browsing users, etc.

When a transaction to purchase the game/VR state object is completed (e.g., after Step 9 and Step 10), then the Source game/VR Client 602B may give up the right to use the game/VR state object. Such relinquishment of use of the state object may be enforced by software on the client, for example.

The following description may include temporary real-time game/VR state transfer (i.e., lease). In addition to permanent real-time game/VR state transfer, temporary real-time game/VR state transfer (or lease) may allow the destination user to utilize and evolve the game/VR state for a limited duration, based on time, events, or other criteria agreed upon by the source user and the destination user. For example, a destination user may want to control a source user's avatar in a massively multiplayer online (MMO) game to use for player-vs-player battles for an afternoon, to assess the abilities and survivability of the source user's avatar and selected skills and abilities at its current experience level.

During the temporary real-time game/VR state transfer, the source user may not generally have the ability to control the avatar while it is under the control of the destination user. However, the source user and destination user may have a coaching agreement which may allow the source user to coach the destination user during the temporary transfer. In this case, the source user may have some ability to control the avatar as part of the coaching process.

Temporary real-time game/VR state transfers may be done for no fee, for a set fee, or on a sliding-scale fee based on the ranking/rating/level of the user's game/VR state, length of temporary transfer time (lease duration), and other parameters to be agreed upon by the source user and destination user, and/or set by the game developers, producers and/or network providers. The combination of temporary real-time game/VR state transfer with coaching may impact the fees associated with the transfer since the source user may be providing both game/VR state and coaching services.

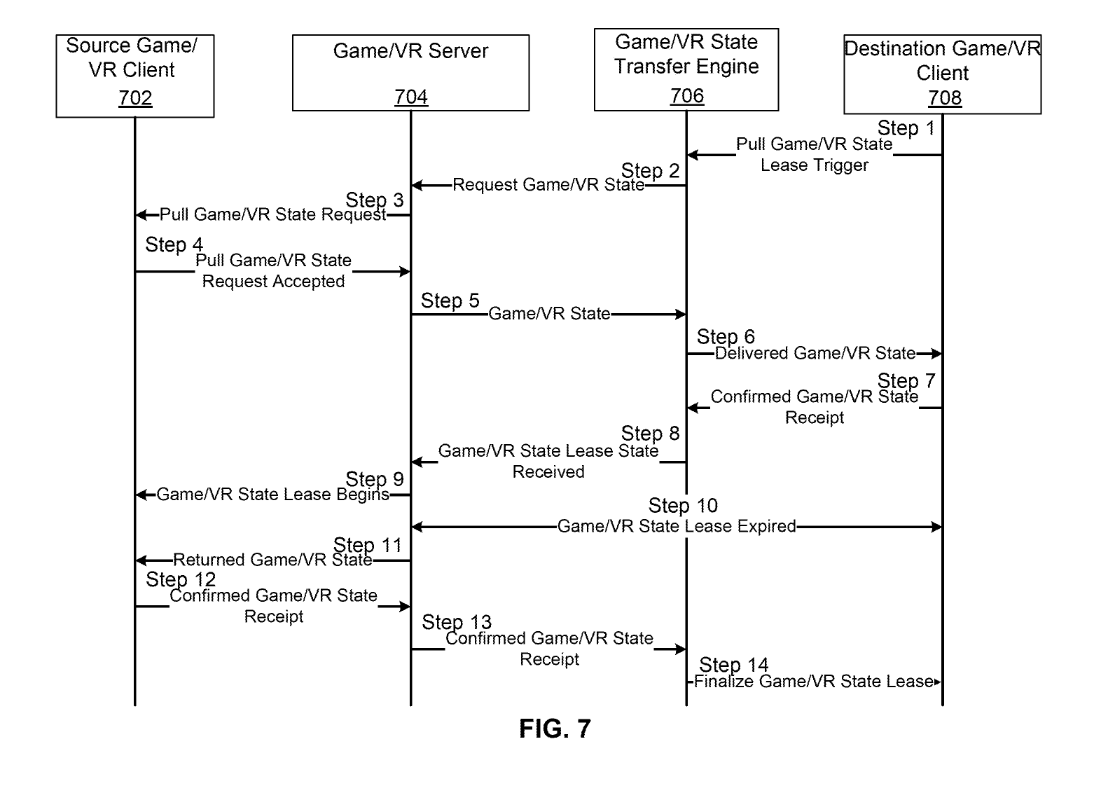

FIG. 7 is a diagram illustrating a message sequence for a temporary pull game/VR state transfer (lease). In Step 1, a Destination Game/VR Client 708, in response to a user request, may send a Pull Game/VR State Lease Trigger message to a Game/VR State Transfer Engine 706. In Step 2, the Game/VR State Transfer Engine 706 may send a Request Game/VR State message to a Game/VR Server 704. In Step 3, the Game/VR Server 704 may send a Pull Game/VR State Request message to a Source Game/VR Client 702, which may respond with a Pull Game/VR State Request Accepted message in Step 4. The Pull Game/VR State Request Accepted message may be sent, for example, after the Source Game/VR Client 702 displays information about the requested lease to a user of the Source Game/VR Client 702, and perhaps after the user provides user input accepting the request.

In Step 5, the Game/VR Server 704 may then deliver the state to the Game/VR State Transfer Engine 706 via a Game/VR State message. In Step 6, the Game/VR State Transfer Engine 706 may send a Delivered Game/VR State message containing the state to the Destination Game/VR Client 708 which may respond with a Confirmed Game/VR State Receipt message in Step 7. In Step 8, the Game/VR State Transfer Engine 706 may inform the Game/VR Server 704 that the Leased state was received in a Game/VR State Lease State Received message. In Step 9, the Game/VR Server 704 then may inform the Source Game/VR Client 702 that the lease has begun via a Game/VR State Lease Begins message.

The Source Game/VR Client 702 may relinquish rights to use the game/VR state during the lease period. In Step 10, once the term of the lease has expired, the Game/VR State Transfer Engine 706 then may send a Game/VR State Lease Expired to both the Destination Game/VR Client 708 and the Game/VR Server 704. In Step 11, the Game/VR Server 704 then may inform the Source Game/VR Client 702 via a Returned Game/VR State message which includes the updated state. This may inform the Source Game/VR Client 702 that the lease has ended, and so the Source Game/VR Client 702 may resume the right to use the game/VR State.

In Step 12, the Source Game/VR Client 702 then may send a Confirmed Game/VR State Receipt message to the Game/VR Server 704, which in turn may notify the Game/VR State Transfer Engine 706 via a Confirmed Game/VR State Receipt message in Step 13. Lastly, in Step 14, the Game/VR State Transfer Engine 706 may finalize the lease termination by sending a Finalize Game/VR State Lease message to the Destination Game/VR Client 708.

The following description may include real-time game/VR state cloning. In contrast to real-time game/VR state transfer, real-time game/VR state cloning may allow the source user to continue to utilize and evolve the game/VR state following the completion of the transaction. In the case of cloning (or forking), the value of the game state may be diluted as there is no exclusivity in the rights to the game/VR state. Also, unlike real-time game/VR state transfer, game/VR state cloning may generally be triggered in a pull fashion (i.e., a spectator may request/purchase access to the game/VR state at a certain point in the evolution of the game/VR state).

Similar to game/VR state transfer, various auction techniques may be used to negotiate pricing and to complete the transaction in real-time game/VR state cloning. Again, either a third party (e.g., a marketplace, which may be a website or an application) or the game/VR provider servers may be used to broker the exchange. In the case of game/VR state cloning, the exchange may be performed with no disruption of the source user's game/VR environment, since the source user may continue to use the original copy of the cloned state. The destination user may be given a countdown timer to indicate when they will be given a cloned game/VR state to begin controlling.

Auction methods may be implemented in-game/VR, outside of the game/VR environment but controlled by game/VR developers and/or producers, by third-party services in-game or outside of the game/VR environment, or by some combination of these methods. Information needed to enable state transfers/clones may include but is not limited to the following: Avatar profile, Current Avatar Status, Current Avatar Location, Avatar Currently Equipped Gear, Avatar Current Inventory, Avatar Open Quest List, Avatar Closed Quest List, Avatar Achievements, Avatar Transfer Availability, Avatar State Transfer Information (full state, partial state, restrictions, cost) and Avatar State Transfer History.

Auction participants may include but are not limited to a combination of the source user, destination users, game/VR developers and/or producers, network providers, and third-party services. Auction capability may be provided and governed by a combination of game/VR developers and/or producers, network providers, and third-party services.

“Instanced” game/VR state cloning may allow the source user to create a copy of the game/VR state and may be limited to a specific challenge, section or level, so that the source user can experiment with different strategies without affecting the real-time game/VR state. In an instanced game/VR state, both virtual coaching and manual coaching may be possible, as disclosed herein. In an example, one way an “Instanced” game/VR state transfer may be used is in an MMO game in which the “Instanced” transfer may allow the recipient to play in an environment that is not shared with other human players. This may likely impact the value of the transfer as the recipient may or may not be able to show other players in the shared world environment the capabilities of their leased game/VR State.

In an example, there may be indicators within the game/VR state that a user is using a transferred/cloned game/VR state. Other aspects may be indicated, such as the number of users who have owned/played this game/VR state, combined statistics regarding the lineage of the users who have owned/played this game/VR state such as average rankings/ratings, and the like. This information may be displayed graphically via icons, text or on-screen special effects applied to the user's avatar that are visible to other game/VR users, or may be displayed in an information panel about the user of a transferred/cloned game/VR state, or a combination of such indicators may be used. Player rankings, multiplayer matches and group makeup may be affected (positively or negatively) by an unskilled user controlling an otherwise well-qualified game/VR state. For example, in a multiplayer game, other players may not want to be grouped with players who have obtained their game state via transfer or cloning. Further, game servers may be configured to allow or not allow such game state transfers or clones in the real-time in game environment.

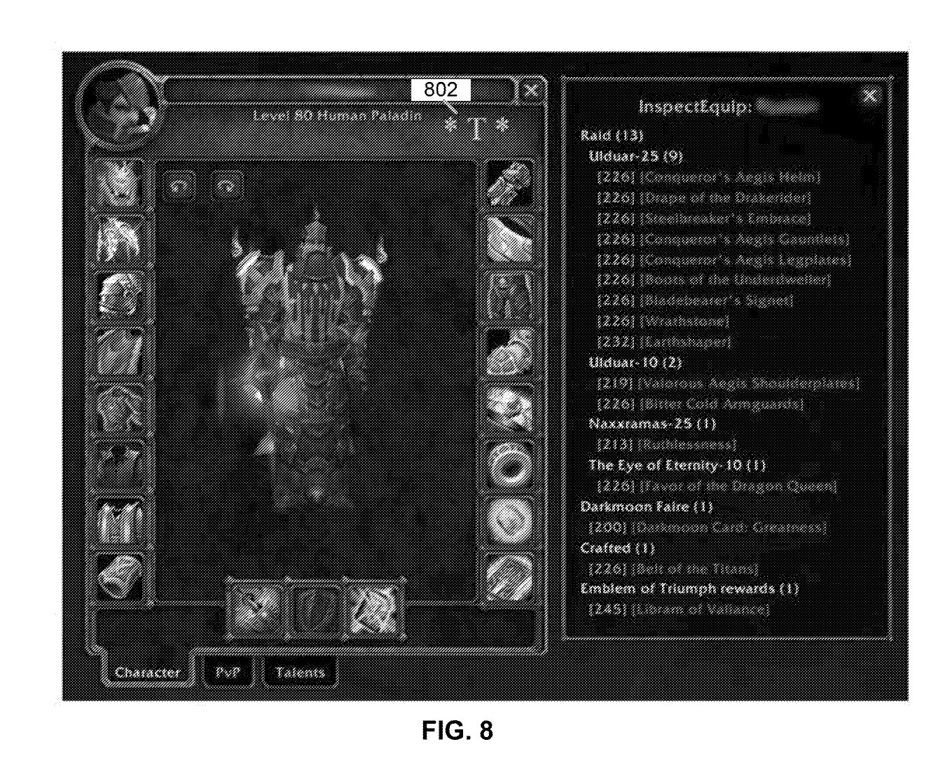

FIG. 8 is a diagram illustrating a game state transfer indicator used in an in-game environment. In the example shown in FIG. 8, the game state transfer indicator used on an information panel for an avatar shown may be the “*T*” text 802 added near the “Level XX Human Paladin” text. A different, larger font was used in this example to stand out, however, actual indicators may utilize the same or different fonts, sizes, colors and other options as other standard in-game text or in information panels.

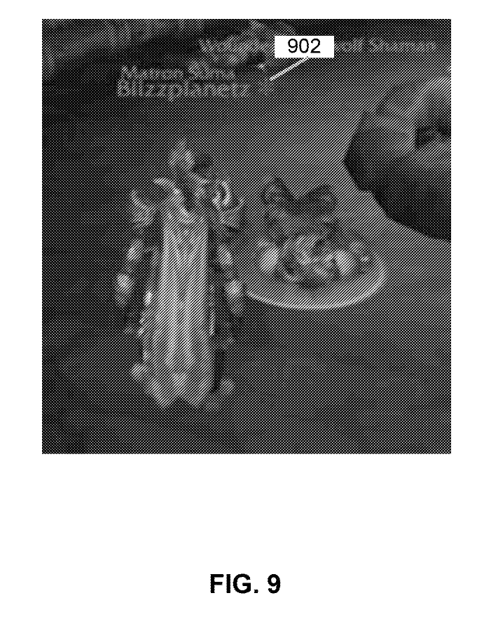

FIG. 9 is a diagram illustrating a game state transfer indicator used in an in-game environment. In the example shown in FIG. 9, the game state transfer indicator used in the in-game environment may be the asterisk, “*” 902, appearing after the avatar's name.

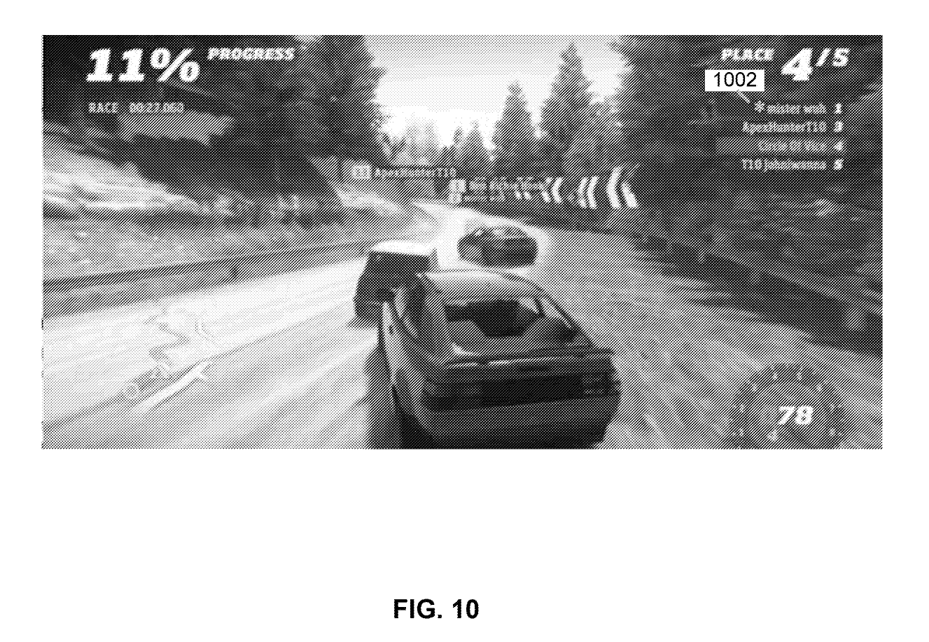

FIG. 10 is a diagram illustrating a game state transfer indicator used in an in-game environment. In an example shown in FIG. 10, the game state transfer indicator used in the in-game environment may be the asterisk “*” 1002 appearing before the user's name in the list to the right of the image. In addition to the examples provided already, the game state transfer indicator may take other forms. For example, the game state transfer indicator may be a graphic symbol, an icon, a text indicator, a special color or highlighting of a character or description of the user's character, or any other indicator suitable for display in a game or a VR experience.

The following description may include offline game/VR state delivery. game/VR spectators may watch via broadcasts such as Twitch™ or offline in a replay fashion using, for example, YouTube™. Existing solutions may allow for the game/VR video and audio (along with gamer commentary) to be viewed by the spectator but may not allow for the spectator to obtain the game/VR state and begin playing/evolving the game/VR at a specific point in time. To facilitate this capability, the game/VR state information may be multiplexed with the game/VR video. This may be accomplished by periodically (e.g., every few seconds) compressing the game/VR state via well-known compression techniques and storing the compressed game/VR state along with the game multimedia (either multiplexed with the multimedia or separately stored by a game/VR state storage server.) The periodicity in time may be a compromise between allowing the spectator to choose the precise instant they wish to initiate a game/VR state transfer and the storage requirements for the multiplexed game/VR state.

In another example, the compression and storage of game/VR state may be event triggered rather than periodic. In this case, events in the game such as spawning a new life or starting a new level may trigger the compression and multiplexing of the game/VR state, and these may form the random access points at which a spectator could initiate the state transfer. While compression of the game/VR state is generally preferred for efficiency of data transfer and storage, it is possible also to use uncompressed snapshots of the game/VR state in the current example, particularly if the size of state objects is already small.

Because the storage requirements may prevent multiplexing the compressed game/VR state with the game/VR multimedia, a request may be made to a game/VR state storage server to retrieve the game/VR state at a particular time within a published game/VR video. In this case, at the time the game/VR video/audio is captured, the game/VR state may also be captured and stored on the game/VR state server. If a game/VR world is not hosted on a game/VR state server, the game/VR state may either be multiplexed with the game/VR video/audio or the source user's application may maintain a history of the evolution of the game/VR state for future transactions.

It should be noted that the key for requesting game/VR state from the storage server may be a timestamp from within the game/VR multimedia or a frame number, or other timecode that the storage server is aware of. In the case that the precise time requested by the spectator does not match the time of a version of the state available in storage, the storage server may respond with the closest (in time) stored game/VR state. The spectator may then choose to accept or reject this state depending on whether it meets their requirements. In order to increase the likelihood that the spectator may find the delivered game/VR state acceptable, an indicator may be rendered with the game/VR multimedia that indicates the availability of game/VR state at that time (or within a certain specified time tolerance, such as 500 ms).

In an example, the spectator may be required to own a copy of the game and/or have a subscription to the game in order to be able to take delivery of and/or use the game/VR state. One mechanism by which the spectator may begin playing a game/VR state is through multipurpose internet mail extensions (MIME) types and/or helper applications. The spectator can view archived gameplay video in, for example, YouTube™, and annotation can indicate the availability of game/VR state. The spectator may then click on the annotation which may then download the game/VR state and launch the spectator's game/VR client.

Similar to real-time game/VR state exchange, the offline game/VR state may be facilitated in an auction. Both exclusive (transfer) and non-exclusive (cloning) of game/VR state may be executed.

The following description may include virtual coaching. Coaching may be the act of one user assisting another user (player) in achieving objectives, improving their performance, or otherwise succeeding within the constraints of the game/VR world. Coaches may provide tips on how other users can improve their gameplay or provide strategies to achieve objectives. Coaches of teams may serve the same role as coaches for individual players with some additional responsibilities, such as managing the roles and responsibilities of the team members. For example, a team coach may assign players “turns” to play while recognizing when players need to rest, or may decide which human user should control a particular game character based on the current in-game conditions and an assessment of the human user's skills and experience. Such dynamic assignments may result in transfers (e.g., temporary transfers) of game/VR state between the different human users on the team, under control and direction of a coach. Coaches of teams may need to develop individual player's skills and abilities and also manage the relationships between the players.

In an embodiment, virtual coaching logic may be provided. The triggering of game/VR state transfer may be initiated based on a set of rules that are triggered based on player/user performance. For example, when a human user becomes fatigued, this may be detected based on in-game performance metrics and/or based on the evolved game/VR state. Such detection may lead to (e.g., may be used to trigger) a change of control (e.g., a transfer of game/VR state) from one human user to another. Virtual coaching may be a holistic responsibility in that the virtual coach may not just take into account the current player/user performance but may also be monitoring for network impairments. Additionally, the virtual coach may in some cases assign a player in a sub-optimal role in order to develop new skills and invest for future game performance. In this way, while the virtual coach will primarily be focused on success in the current goals, a longer time perspective will also be considered.

In further examples, virtual coaching may apply to Tele-Surgery, remotely piloted aircraft, and other environments in which the user's interaction with a Virtual Reality is captured and processed by the Game/VR State Transfer Engine.

The following description may include manual coaching. In an example of manual coaching, a human coach may be tasked with triggering changes in control of a game/VR user. This role may be similar to group leaders with the additional capability to transfer control of virtual actors in the game/VR environment between different human users. For example, a human coach may remotely view the gameplay of a set of human users (e.g., a team of users), and the human coach may trigger game/VR state transfers (e.g., temporary state transfers) between human users in order to control and to improve team performance. To this end, a user interface (UI) may be provided which displays the current gameplay involving one or multiple game characters, and which indicates to the human coach which human users (e.g., by name, call sign or account name) are currently controlling each of the game characters. The UI may allow the human coach to select a game character in order to trigger a state transfer, and to select a new human user to control the selected game character. For example, a list of human users (e.g., users on the coach's team) may be displayed when the coach selects a game character, and the coach may then select a human user to be the destination of the state transfer for that game character. As a result, a game/VR state transfer may be initiated for the game/VR state associated with the selected game character, and the game/VR state may be transferred from the original human user to the human user newly selected by the coach.

For both virtual coaching and manual coaching, source users may rate their coaches for helpfulness, trust, communication skills, patience, and other qualities (e.g., other parameters related to coaching performance) that can affect the interaction between source users and coaches as well as the overall results of the coaching. A context aware on-line help system for customer relationship management may be used for shadowing the player and offering help service based on events of interests such as killing a big monster or solving a puzzle. On detecting events indicating that a player may need help on a particular event of interest, the on-line help system may deliver the help content that is relevant to the events of interests to the player. The effectiveness of the on-line help may be rated based on player's score or the time it took to pass the events of interests.

To encourage game/VR users to participate in virtual and/or manual coaching, as either a coach or as a user who receives coaching from another user, recognition in the form of in-game achievements, trophies or equivalent indicators may be employed. In an example, achievements may be used with an Xbox™ system and trophies may be used in a PlayStation™ system. Other forms of recognition may include in-game rewards (e.g., special skills, gear or effects) or other benefits granted by the game/VR server. Such recognition could be factored into coaching ratings as disclosed herein.

In an example, coaching may be crowdsourced. In a further example, game play may be crowdsourced. A game/VR state user may be crowd-coached by one or more manual coaches, where the next move to be executed by the source user may be selected by voting among the manual coaches. This concept may be applied in a manual coaching environment, in an instanced environment, and/or in the real-time game environment. The next move for the crowd-coached or crowd-controlled avatar in any environment may be determined by voting among the group of users making up the avatar's coaches or in-game/VR team. The voting may be uniform or weighted based on coaching ratings, as disclosed herein. Crowd-coached avatars may compete in any game environment against other crowd-coached avatars, against individual users, or against the game/VR-controlled avatars. Crowds may be made up of pre-organized teams (e.g., guilds), or teams organized within the game/VR environment prior to a match or event (e.g., pre-event lobby), by the game/VR servers (e.g., similar rank, level, geographical region or other criteria), or on a random basis. The teams may be determined by rules for each game/VR server.

The game/VR servers may monitor real-time game environments for indications of fraud and/or misuse based upon rules for each server (e.g., majority of users on a crowdsourced team voting for a move or moves that will lead to defeat or other undesired outcome), and may alter, restart, or conclude a game/VR match based upon the rules set for the server(s). Rules may vary from game/VR server to server (e.g., all North America, all level X or above/below, and the like).

In an embodiment, a user may be playing chess or another turn-based strategy game. The user may be associated with a certain number of crowd-coaches which may be remotely viewing the gameplay. The crowd-coaches may be a specific team of coaches associated with the user, or they may simply be spectators of the game (e.g., via an online gaming spectation system such as Twitch™). When it is the user's turn to move, the crowd-coaching system (which may be integrated into the game/VR server which is serving the chess game to the users, may be integrated with the spectation system, or may be hosted in a separate computing device in communication with the game/VR server and/or the spectation system) may solicit input from the crowd-coaches. Such solicitation may ask each crowd-coach what move the user should make next. The crowd-coaching system may allow a certain amount of time (e.g., 15 seconds or one minute) for the various crowd-coaches to provide input via a crowd-coaching UI accessible to each crowd-coach, or the system may wait until a certain number of crowd-coaches (or a certain percentage of available crowd coaches) have provided their inputs.

In the chess game example, the crowd-coach UI may allow each crowd coach to select one of the user's pieces and to specify a destination space to which the selected piece should be moved. The crowd-coaching system may then aggregate the received inputs and may determine a most popular recommended move. For example, if 37 crowd-coaches respond in the allowed time interval, and if the most popular recommended move among the received responses is “Nf3,” then the crowd-coaching system may select “Nf3” as the recommended move. The system may provide this recommended move as input to be displayed to the user who is playing the chess game. For example, the game/VR server and/or the user's client may display a message to the user such as “Crowd Coaches Recommend ‘Nf3.’” Then the user may react accordingly to the crowd coached input. For example, the user may move his knight to position f3, or the user may ignore the advice and make a different move.

In another embodiment, the crowd-coach system (e.g., the game/VR server or the user's client) may display multiple crowd-sourced inputs, possibly indicating the number of crowd-coaches or the percentage of the crowd-coaches which recommended each of the inputs. For example, the system may display to the user that “Nf3” was recommended by 33% of the responding coaches, and “e4” was recommended by 21% of the responding coaches, and so on. Such a system may display to the user all of the recommended inputs together with the number of responses or percentage of responses, or it may display a limited number of recommended inputs (e.g., the top 3 or top N responses received from the crowd-coaches).

In another embodiment, a user may be playing a real-time game such as an action or exploration game. As in the previous example, a certain number of crowd-coaches may be remotely viewing the gameplay in real-time. The crowd-coaches may be a team of coaches with some arranged association to the user, or they may simply be spectators of the game (e.g. via an online gaming spectation system such as Twitch™). Again there may be a crowd-coach system integrated to the game/VR system which is serving the game to the user, may be integrated to the spectation system, or may reside in a separate computing device in communication with the game/VR server and/or the spectation system (e.g., over a network). The crowd-coach system may solicit input from the crowd-coaches in order to determine recommendations to make to the user in the course of the user's gameplay. In one embodiment, the crowd-coach system may solicit input from the crowd-coaches at periodic intervals. In another embodiment, the crowd-coach system may solicit input from the crowd-coaches continuously.

For example, each crowd-coach may have a user interface which allows the crowd coach to remotely view the user's gameplay, and which provides the crowd-coach with a continuous opportunity to input coaching recommendations at any time the crowd-coach chooses to provide input. In still another embodiment, the crowd-coach system may solicit input from the crowd-coaches in response to states or events encountered in the gameplay. For example, if the user is traveling on a road within the game and the user approaches a fork in the road, the crowd-coach system may prompt each crowd-coach to recommend whether the user should take the left fork, take the right fork, or go back.

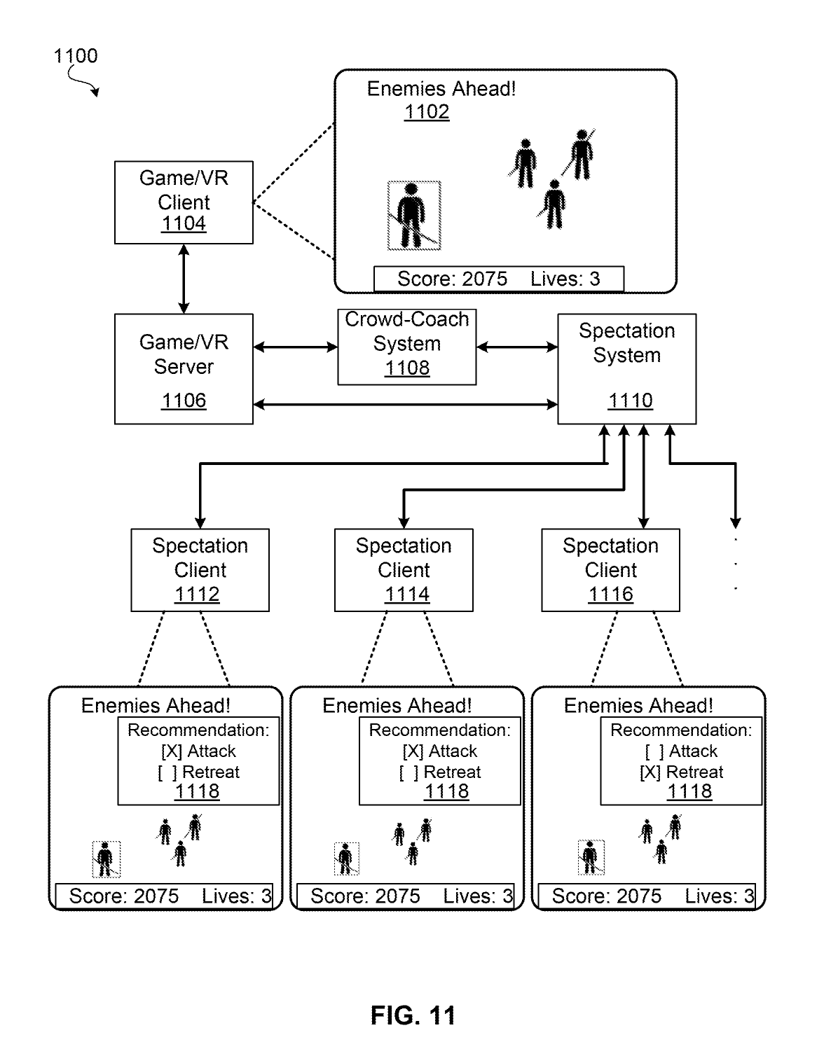

FIG. 11 is a diagram illustrating a crowd-coach system 1100. In an example, if the user approaches a band of enemies in the game, the crowd-coach system may prompt each crowd-coach to recommend whether the user should attack, retreat, or attempt to go around the enemies.

In an embodiment, a Game/VR Server 1106 may detect an event 1102 in a Game/VR Client 1104 which may trigger crowd-coach input (e.g., the user is approaching a band of enemies). The Game/VR Server 1106 may send a message to a Crowd-Coach System 1108, which may indicate that crowd-coach input is requested. The message may specify how the input is to be solicited from the crowd-coaches, for example the message may enumerate multiple choices from which the crowd coaches or spectators may select, or the message may specify that freely typed crowd coach input is allowed. The Crowd Coach System 1108 may communicate with a Spectation System 1110 to specify how the crowd-coach input solicitation should be displayed, and to indicate what type of input is solicited. Multiple crowd coaches (e.g., spectators) may be viewing the original user's gameplay via the Spectation System 1110. This may be done using the individual clients or Spectation Clients 1112, 1114, 1116 of the spectators. At the direction of the Crowd-Coach System 1108, the Spectation System 1110 may display a user interface 1118 to each of the crowd coaches. The user interface 1118 may be overlaid on the gameplay view, for example. The user interface 1118 may specify multiple coaching recommendation choices, or may allow for a more free-form input such as typing text.

The crowd-coaches may react to the display of the user interface 1118 by selecting one of the available coaching recommendation choices, or by providing other user input (e.g., typing text to indicate a recommendation). The Spectation System 1110 may relay the crowd-coach inputs (either individually or a tallied or aggregated form) to the crowd-coach system. The Crowd-Coach System 1108 may analyze the crowd-coach inputs, for example it may determine the most popular recommendation provided by the crowd coaches, or the N most popular recommendations. The Crowd-Coach System 1108 may decide what recommendation should be displayed for the original user. The decision may be made based on elapsed time (e.g., based on all recommendation inputs received within 5 seconds of requesting user input from the crowd coaches). Alternately the decision may be made after some minimum number of crowd-coach recommendation responses (e.g., 50 or 100 responses) are received by the crowd coach system. Once the decision is made, the Crowd-Coach System 1108 may send a message to the Game/VR Server 1106 to inform the server of the selected crowd-coach recommendation.

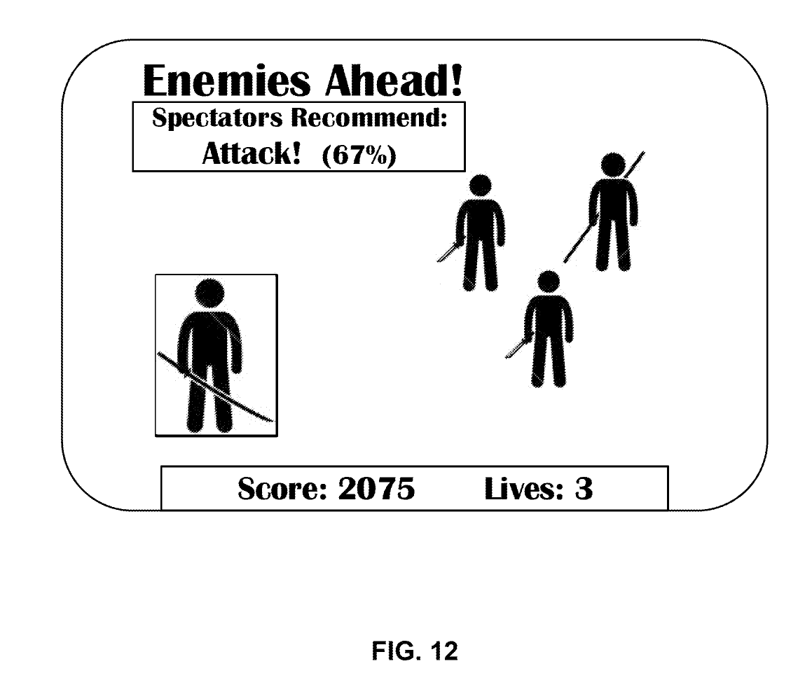

FIG. 12 is a diagram illustrating a display of a recommendation in a crowd-coach system. As described above with reference to FIG. 11, the Game/VR Server 1106 may display the resulting recommendation to the original user via the Game/VR Client 1104.

In another example, multiple users may be playing a team soccer game. Spectators who are fans of the team may be watching the game play in real time (e.g., via a spectation system), and may have a crowd-coach UI which allows them to indicate when they think a particular user should be removed from the game, and when a particular benched user should be put back into the game. The crowd-coach UI may be available continuously to the spectators, so that each spectator may at any time select a playing user for removal, or may select a benched user for return to the game.

As the spectators provide such crowd-coach recommendation inputs, the inputs may be communicated from the spectation clients to the Crowd-Coach System 1108, for example, via the Spectation System 1110. The Crowd-Coach System 1108 may monitor and aggregate the recommendations. When a certain number or percentage of spectators recommend removing a player from the game, the Crowd-Coach System 1108 may forward this recommendation to the Game/VR Server 1106. Likewise, when a certain number or percentage of spectators recommend restoring a benched player to the game, the Crowd-Coach System 1108 may forward this recommendation to the Game/VR Server 1106.

As a result, the Game/VR Server 1106 may display such recommendations to a human coach or team captain playing the game, and the human coach or team captain may respond to the crowd-source recommendations by removing players from the game and/or restoring players into the game. Alternately, the Game/VR Server 1106 may have an automatic function (e.g., a virtual coach) which implements the crowd-coached recommendation to remove a player and/or restore a player without further input from a human coach or team captain. In either case, the act of replacing a first human user with a second human user may trigger a transfer of game/VR State from the first user to the second user, based on any of the state transfer techniques disclosed herein.

The following description may include game/VR transfer policy restrictions that may be used in the embodiments disclosed herein. As disclosed herein, pre-defined policies may be enforced by the Game/VR State Transfer Engine. The following are a set of example policy dimensions or policy terms that may be enforced.

The number of transfers/clones of a game/VR state may be limited per user for transfers/clones in, out, or total amount. Also, the number may be limited per time interval for transfers/clones in, out, or total amount. Further, the number may be limited per game/VR state (e.g., Avatar) for transfers/clones in, out, or total amount. In addition, the number may be limited per game/VR state per time interval (e.g., Avatar) for transfers/clones in, out, or total amount.

Further, the transfer/clone of a game/VR state may be restricted to be between users who have achieved a certain rating/ranking/level or any other attribute of the user profile. Also, the transfer/clone may be restricted to be between users with a certain difference in rating/ranking/level. Further, the transfer/clone may be restricted to be between game/VR states (e.g., Avatars) with a certain rating/ranking/level. In addition, the transfer/clone may be restricted to be between users on the same or on different game/VR servers. In another example, the transfer/clone may be restricted to be between users in the same or in different geographical regions.

Transfers/clones of a game/VR state may be restricted to a certain time interval (e.g., state is returned or destroyed within a certain period of time for transfers or clones respectively). Also, transfer/clones of game/VR state may be denied for users who have been identified as abusive or exploitative in the past.

Transfers/clones of a game/VR state may be restricted to specific game/VR server instances. Transfers/clones of a game/VR state may require the purchase of a special subscription, feature or bundle of features. Transfers/clones of a game/VR state may be limited to certain partial state information, as disclosed herein.

The following description may include partial game/VR state transfers. The transfer of game/VR state may not include the complete space described and maintained on the game/VR server and/or game clients. For example, partial game/VR state transfers may include any subset of the following: game/VR assets (e.g., equipment/gear); game/VR achievements (e.g., trophies); game/VR ranking/ratings/level; game/VR skills (e.g., ability to create certain objects); game/VR specifications (e.g., specialization enabling certain capabilities); game/VR abilities; game/VR attributes (e.g., avatar strength, agility, etc.); game/VR appearance (e.g., the aesthetics of an avatar); game/VR in-game/in-VR access to levels, sections, areas, zones, portals, instances, and other special access areas where access is earned via permission, completion of tasks/quests, and/or completion of other criteria; game/VR social network (NW) (e.g., teaming arrangements, friends, etc.); game/VR social NW media and content (e.g., messages, images, video, site access, etc.); and OTT game/VR accounts and content specific to the account/avatar being transacted (e.g., social network messages).

An example for the use of partial game/VR state transfer is the case of limiting the transfer of social network aspects of the game/VR state. A user may be willing to transfer or lease their game/VR state but may not be willing the share their friends, guild mates, team members, or other aspects of their social network.

In another example of partial game state transfer, a user may be willing to transfer or lease their equipment, skills, ranking, but may not be willing to transfer their avatar's appearance. In another example, a user may be willing to lease or transfer their earned access to levels or sections but not being willing to transfer or lease any other aspect of their game/VR state.

In such cases, the partial transfer of game/VR state may in some cases be combinable with an existing game/VR state of the recipient. For example, a recipient may receive a partial game/VR state, which includes access to levels 1-12 of a game, and also includes several inventory items (e.g., a special sword, a shield, and a book of spells). Upon receiving the partially transferred game/VR state, the recipient may select an existing character owned or created by the recipient, and the level access, game items, and other attributes received in the partial state transfer may be added to the game/VR state of the selected character.

The following description may include a proxy for over the top (OTT) transfer. Conventional solutions may not allow for the integrated, in-game/VR transfer of game/VR state between users, but there may be OTT solutions. In these cases, a transaction may be made on a third party website or directly between the two parties and credentials are exchanged. Embodiments described herein may facilitate OTT transactions of game/VR state by embedding the functionality of the Game/VR State Transfer Engine and the Event Pattern Detection Engine in a third party proxy function, which may serve as an intermediary for Game/VR State and Control. The third party proxy function may present itself to the Game Server as a Game Client.

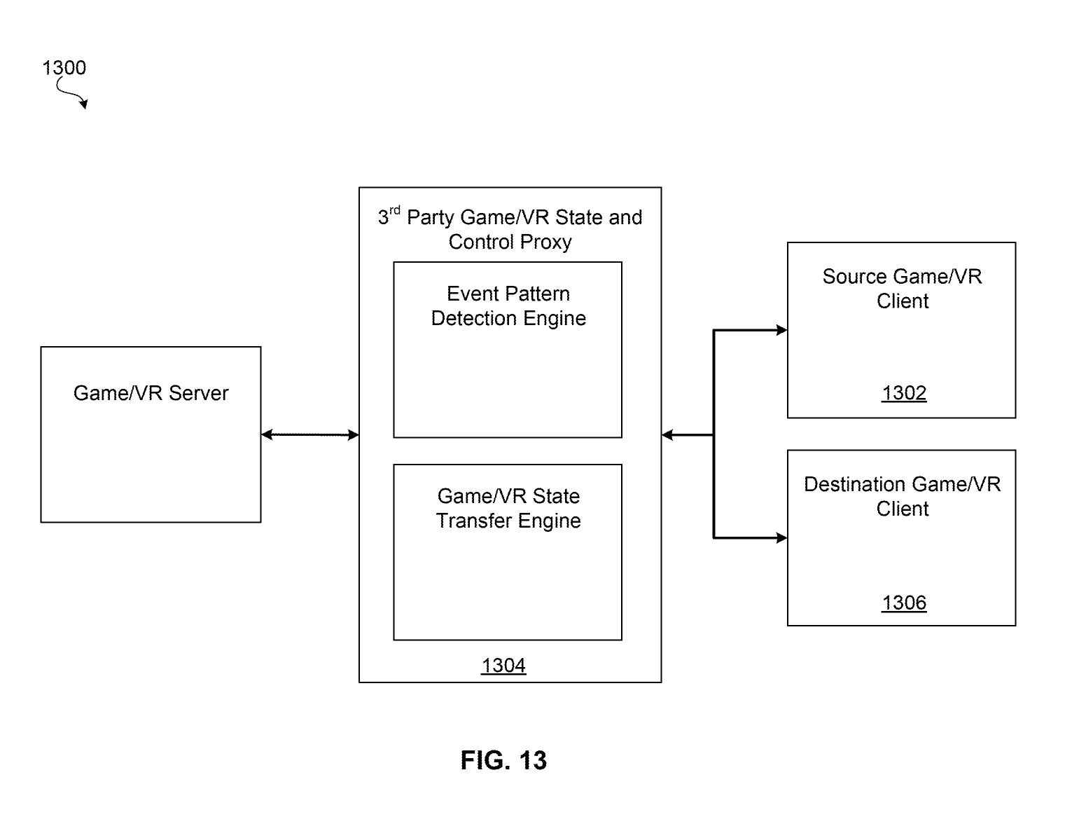

FIG. 13 is a diagram illustrating a functional partition for a third party game/VR state and control proxy system 1300. The entities shown in FIG. 13 may be similar to those described above with reference to FIGS. 3-7. In an embodiment, a Source Game/VR Client 1302 may play the game with state and control information being communicated via a Third Party Game/VR State and Control Proxy 1304 until the game/VR state transfer is initiated. Once the transfer is completed, the control information may come from a Destination Game/VR Client 1306 and the Source Game/VR Client 1302 may no longer be in control. As described herein, the trigger for the Game/VR State Transfer may be pull, push, or automatic.

The following description may include the transfer of an augmented reality (AR) state from one AR user to another AR user. For example, one AR user may select objects of interest in the real world using augmented reality markup, may create virtual annotations or artwork, may build virtual models using tools and materials available in an AR application, or may collect virtual objects and solve puzzles within an AR game. Such modifications or annotations of the natural world may form part or all of an AR state, and such state may be transferred from one AR user to another AR user according to any of the transfer techniques disclosed or described herein. For example, AR states may be transferred, cloned, or instanced. AR state transfers may occur at the source user's direction, at the destination user's direction, or automatically based on the detection of a triggering pattern. As additional examples, AR states may be sold, leased, or offered via a marketplace, may be wholly or partially transferred, may be transferred subject to restrictions, and the like.

An AR state may be relevant to a geographic location or area. For example, an AR application may be relevant to (or restricted to) a theme park attraction, an art museum, a city, a local park, a residence, or other geographical location. In this case, the transfer of the AR state from a first user to a second user may be allowed if the second user is within the geographical location or area to which the AR application or experience is relevant, or to which it is restricted. Such restriction may apply for any of the transfer scenarios or triggering mechanisms described herein.

For example, a user may be playing an AR game in which the user wanders the streets of San Francisco looking for virtual treasures. The user's AR goggles may provide hints (e.g., trivia questions whose answers suggest well known locations or landmarks within the city), and the user may respond by walking around the city to discover the virtual treasures hidden at those locations or landmarks. The user may thus accumulate treasures and points, may advance in skill level. The user may offer his AR state for the game via a marketplace or other state transfer mechanism, and another user may request to purchase, lease, or otherwise receive the AR state. The other user may have a suitable pair of AR goggles. However, the system (e.g., the marketplace, the state transfer engine, or an application server for the AR game) may check that a geographical constraint is satisfied—that is, it may check that the receiving user is currently located in San Francisco where the AR game is relevant. If this geographical constraint is not satisfied, then the system may prevent the transfer of the AR state to the receiving user.

The system may likewise check that the receiving user has a suitable AR display apparatus, and/or that the receiving user has the right to play the AR application or game. If either of these conditions is not met, the system may prevent the transfer of the AR state to the receiving user.

In another example, an AR state transfer may be allowed beyond the geographical location or area of relevance for the AR application or game. In this case, the AR application or game (and its associated relevant physical location) may be recreated for the receiving user as a VR experience. For example, a user may play the treasure hunting game on the streets of San Francisco as described above. The user may thus build an AR state (e.g., may discover treasures, accumulate points, build a skill level, and the like). The AR state may then be transferred to a second user who lives in Chicago.

The second user may not be able to travel to San Francisco to play the original AR game. However, the second user may experience the AR treasure hunt application using VR. That is, the second user may have a VR display apparatus (or another computing device in communication with the VR display apparatus) which may receive the original user's AR state, and which may additionally access a virtual model of San Francisco suitable for display and interaction within the VR display apparatus of the second user.

A VR version of the AR treasure hunt game may be displayed using the VR display apparatus of the second user. This version may display the buildings, streets and landmarks of San Francisco using the virtual model of San Francisco, and may also provide (e.g., overlay) the virtual hints and clues, and also the virtual treasures at the locations in the virtual model which correspond to the locations in the physical world of San Francisco in which the AR treasure hunt game would normally display these items. In this way, the receiving user may experience the AR treasure hunt game, and may receive and utilize a transferred AR state for this game, using a Virtual Reality version (e.g., a VR approximation) of the original AR application. In this case, no geographical area restrictions need be imposed on the state transfer.

In a further example, the receiving user may provide the resulting state as source for additional state transfers. For example, the state may be transferred from the second user in Chicago to a third user in New York (who may then experience the treasure hunt game using a VR version of the application along with the model of San Francisco and the received state). As another example, the state may be transferred to a fourth user in San Francisco (who may then experience the treasure hunt game using the AR version of the application on the physical streets of San Francisco). In this way, a game/VR state may transition (e.g., may arbitrarily transition) between AR and VR versions of a game or other application.

The following description may include detailed examples of the game/VR state transfer function components and user cases disclosed herein. Table 1 provides example multiple game session tasks and contexts. For example, the data model for recording the states of the game session may include IDs for the game, game session, and tasks that the player is currently engaging in. The data model may also consist of the types of AI opponents capabilities, such as skill and range of audio and visual detection capabilities. In addition, the data model may include the role of avatar and the finite state machine (FSM) action states that the avatar is performing. The location of the avatar may also be recorded as context information.

TABLE 1
Example multiple game session tasks and contexts

| GameID. | Game AI | Player | FSM | |
|---|---|---|---|---|
| SessionID. | characteristic | Avatar | Action | Point of |
| TaskID | parameters | Role | States | interests |
| G1.S2.TK3 | {Name, Type, | Avatar ID | Puzzle | Zone1 |
| | Skill level, | | | |
| | Range} | | | |
| G2.S3.TK2 | {Name, Type, | Attacker | Shoot | Zone4 |
| | Skill level. | | | |
| | Range} | | | |
| G3.S3.TK2 | AI M3-CP: | CarType | Drive | Track |
| | {Skill, . . .} | | | |
| G4.S3.TK2 | AI M4-CP: | Defender | Run | Base |
| | {Speed, . . .} | | | |
| G5.S3.TK2 | AI M5-CP: | Collector | Collection | Resource |
| | {Score Rate, . . .} | | | |

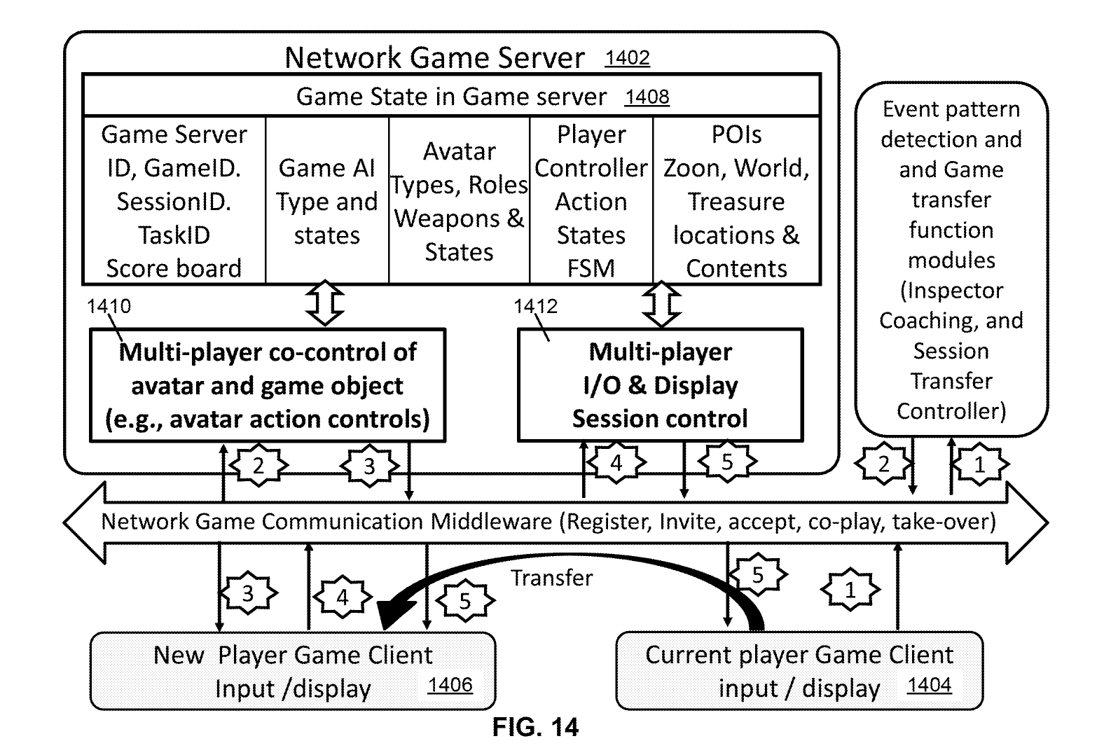

FIG. 14 is a diagram illustrating game control transfer function modules and control flow. The game state transfer mechanism may support seamless transfer of a game state with minimal disruption of the game to the players. As disclosed herein, the mechanism may comprise function modules in a Network Game Server 1402 as well as a Current Player Game Client 1404 and a New Player Game Client 1406 to support the game state transfer. The function modules may include a game state tracking object 1408, an avatar co-control module 1410, and a player Input/Output display session control 1412. The game state transfer mechanism may support an API for an external game state transfer engine or proxy control proxy or both. As shown in FIG. 14, game control transfer function modules and control flow may support context aware game state transfer between players.

The game state may be modeled as shared objects with access interfaces to control the permission and create, read, update, and delete (CRUD) operations through the co-control module. When receiving a request for game state transfer, the co-control module may create a transfer control object that includes the player name IDs involved in the transfer and handles to the game states. Depending upon the type of transfer, the control object may either create a copy of the game state for migrating the game to other servers or provide session control handles of the current player to the new player. When the transfer is triggered either by the event pattern detection module or by the player manually, the new player may first accept the transfer request and then register to the game to gain access to the avatar and game display through the session controller. The game transfer control object may provide the handle of itself to the game transfer engine using a message interface as described earlier.

The following is a list of objects that may be managed by the game state transfer control object: TransferControlObjectDescriptor; ActionState; AvatarRoles; partial game states; Points of Interests (POIs) Map; pre-recorded POI contents; and avatar action state and parameter tracking. Further, the TransferControlObject-Descriptor may include TransfererInfo, TransfereeInfo, GameInstanceID, Playtime-Info, and Secure token (for the transfer request and game access authentication). An ActionState may be an FSM which describes the state of the avatar (e.g., running, shooting, hiding, solving puzzle, collect resources). AvatarRoles may include co-player roles such as leader, worker, and fighter. Partial game states may include object property, ownership and access rights as described herein.

POIs may be an important part of the game context that triggers the transfer of control. The trigger point may be detected by the event pattern detection function module in the game state transfer engine. POI may define the time and place where the tasks and events are happening in the game world. Different types of events may happen in each occurrence of POI. POI, event type and time stamp can be used as reference (index and descriptor) points for deciding the label and time period of pre-recording. Events associated with POIs typically are associated with a victory or beginning and ending of a session. Examples of POI locations consist of locations in the game world including: way points and obstacles; resources (treasures/weapons); obstacles and puzzles; and entries and exit points.

Pre-recorded POI contents may be generated because players may continuously record action events, avatar behavior, and/or Machinima video. The handles to the pre-recorded content at POIs may include achieving a victory in short period of time or killing a big monster in a specific game session. The pre-recorded content may be used for coaching other players, as described herein.

The avatar action states shown in FIG. 14 may be part of the FSM that may control the autonomous actions of the avatar. Each action state may be associated with some player behavior characteristic parameters. All the state transition events and the parameters associated with each state may be collected and tracked. For example, one of the avatar action states, “running,” may contain a parameter “speed” as a characteristic parameter. A player may transition from running to shooting and then to running in response to different game events (e.g., appearance of an enemy). These transition patterns may be tracked by the event pattern detection module to help decide the POI and least disrupting moment to transfer the game.

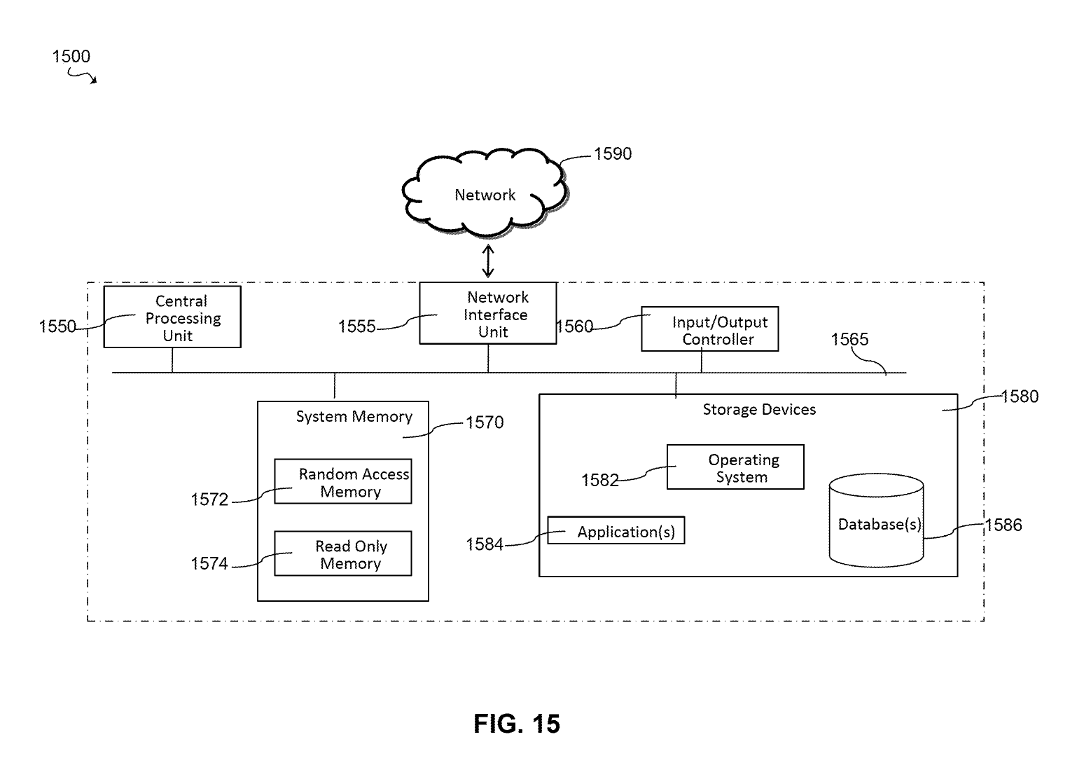

FIG. 15 is a component diagram of a server 1500 that may be used in the embodiments described above. The server 1500 may include one or more central processing units (CPU) 1550, network interface units 1555, input/output controllers 1560, system memories 1570, and storage devices 1580. Each CPU 1550, network interface unit 1555, input/output controller 1560, system memory 1570, and storage device 1580 may be communicatively coupled via bus 1565.

The system memory 1570 may include random access memory (RAM) 1572, read only memory (ROM) 1574, and one or more cache. The storage devices 1580 may include one or more applications 1584, an operating system 1582, and one or more databases 1586. The storage devices 1580 may take the form of, but are not limited to, a diskette, hard drive, CD-ROM, thumb drive, hard file, or a Redundant Array of Independent Disks (RAID).

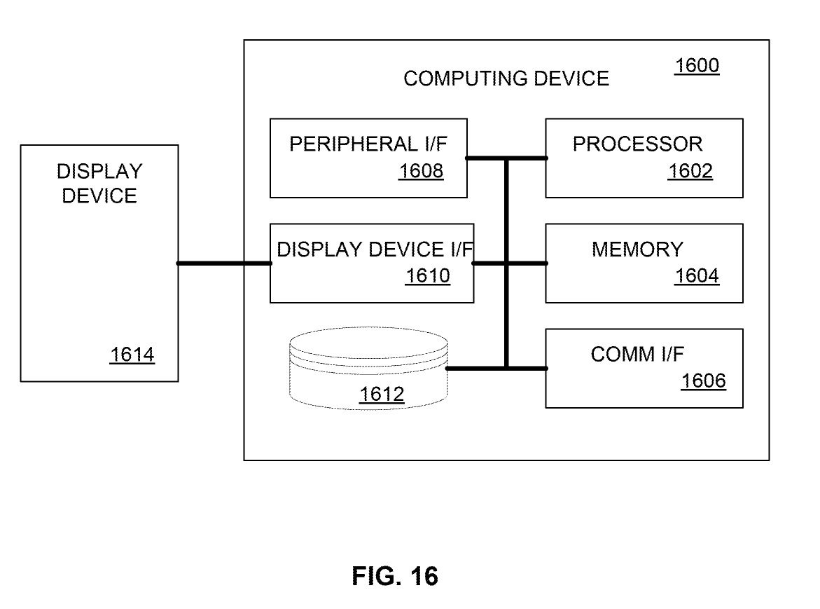

FIG. 16 is an example computing device 1600 that may be used to implement features of the devices described above is shown. The computing device 1600 may include a processor 1602, a memory device 1604, a communication interface 1606, a peripheral device interface 1608, a display device interface 1610, and a storage device 1612. FIG. 16 also shows a display device 1614, which may be coupled to or included within the computing device 1600.

The memory device 1604 may be or include a device such as a Dynamic Random Access Memory (D-RAM), Static RAM (S-RAM), or other RAM or a flash memory. The storage device 1612 may be or include a hard disk, a magneto-optical medium, an optical medium such as a CD-ROM, a digital versatile disk (DVDs), or Blu-Ray disc (BD), or other type of device for electronic data storage.

The communication interface 1606 may be, for example, a communications port, a wired transceiver, a wireless transceiver, and/or a network card. The communication interface 1606 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 1608 may be an interface configured to communicate with one or more peripheral devices. The peripheral device interface 1608 may operate using a technology such as Universal Serial Bus (USB), PS/2, Bluetooth, infrared, serial port, parallel port, and/or other appropriate technology. The peripheral device interface 1608 may, for example, receive input data from an input device such as a keyboard, a mouse, a trackball, a touch screen, a touch pad, a stylus pad, and/or other device. Alternatively or additionally, the peripheral device interface 1608 may communicate output data to a printer that is attached to the computing device 1600 via the peripheral device interface 1608.

The display device interface 1610 may be an interface configured to communicate data to display device 1614. The display device 1614 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1610 may operate using technology such as Video Graphics Array (VGA), Super VGA (S-VGA), Digital Visual Interface (DVI), High-Definition Multimedia Interface (HDMI), or other appropriate technology. The display device interface 1610 may communicate display data from the processor 1602 to the display device 1614 for display by the display device 1614. As shown in FIG. 16, the display device 1614 may be external to the computing device 1600, and coupled to the computing device 1600 via the display device interface 1610. Alternatively, the display device 1614 may be included in the computing device 1600.

An instance of the computing device 1600 of FIG. 16 may be configured to perform any feature or any combination of features described above. In such an instance, the memory device 1604 and/or the storage device 1612 may store instructions which, when executed by the processor 1602, cause the processor 1602 to perform any feature or any combination of features described above. Alternatively or additionally, in such an instance, each or any of the features described above may be performed by the processor 1602 in conjunction with the memory device 1604, communication interface 1606, peripheral device interface 1608, display device interface 1610, and/or storage device 1612.

Although FIG. 16 shows that the computing device 1600 includes a single processor 1602, single memory device 1604, single communication interface 1606, single peripheral device interface 1608, single display device interface 1610, and single storage device 1612, the computing device may include multiples of each or any combination of these components 1602, 1604, 1606, 1608, 1610, 1612, and may be configured to perform, mutatis mutandis, analogous functionality to that described above.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of transferring state information of a first user in an interactive gaming environment to a second user, the method comprising:
receiving, by a state transfer engine, an automatic transfer trigger from an event pattern detection engine monitoring the first user's performance within the interactive gaming environment, wherein the automatic transfer trigger is generated by the event pattern detection engine upon detecting parameters related to a change in the first user's performance in one or more updates sent from a game server that is hosting the interactive gaming environment and allowing the first user to participate and the second user to spectate using corresponding devices;
requesting, by the state transfer engine, the state information of the first user from the game server, wherein the state information of the first user comprises a current status of the interactive gaming environment and the first user within the interactive gaming environment;
receiving, by the state transfer engine, the state information of the first user; and
sending, by the state transfer engine, the state information of the first user to the second user, such that the second user takes over the participating at the current status of the interactive gaming environment and the current status of the first user within the interactive gaming environment.

2. The method of claim 1, further comprising:
receiving, by the state transfer engine, a confirmation of the receipt of the state information of the first user from the second user; and
sending, by the state transfer engine, a state transfer complete message to the game server.

3. The method of claim 1, wherein the state transfer engine is co-located on the game server.

4. The method of claim 1, wherein the state transfer engine is located on a server external to the game server.

5. The method of claim 1, wherein the detecting parameters related to the change in the first user's performance comprises monitoring the first user's actions in the interactive gaming environment for one or more predetermined patterns.

6. The method of claim 1, wherein upon the sending the state information of the first user to the second user, the first user ceases participating in the interactive gaming environment.

7. The method of claim 1, wherein upon the sending the state information of the first user to the second user, the first user continues participating in an instanced interactive gaming environment without interruption.

8. The method of claim 1, wherein the interactive gaming environment comprises a virtual reality (VR) or augmented reality (AR) environment.

9. The method of claim 1, further comprising:
sending, by the state transfer engine, state information of the second user to the first user upon the second user advancing within the interactive gaming environment based on the state information of the first user.

10. The method of claim 5, wherein the one or more predetermined patterns comprise a crowdsourced input from additional users of the interactive gaming environment.

11-20. (canceled)

21. A state transfer engine for transferring state information of a first user in an interactive gaming environment to a second user, the state transfer engine comprising:
an interface;
a processor operatively coupled to the interface, the processor configured to receive an automatic transfer trigger from an event pattern detection engine monitoring the first user's performance within the interactive gaming environment, wherein the automatic transfer trigger is generated by the event pattern detection engine upon detecting parameters related to a change in the first user's performance in one or more updates sent from a game server that is hosting the interactive gaming environment and allowing the first user to participate and the second user to spectate using corresponding devices;
the processor further configured to request the state information of the first user from the game server, wherein the state information of the first user comprises a current status of the interactive gaming environment and the first user within the interactive gaming environment;
the processor further configured to receive the state information of the first user; and
the processor further configured to send the state information of the first user to the second user, such that the second user takes over the participating at the current status of the interactive gaming environment and the current status of the first user within the interactive gaming environment.

22. The state transfer engine of claim 21, wherein the processor is further configured to receive a confirmation of the receipt of the state information of the first user from the second user and send a state transfer complete message to the game server.

23. The state transfer engine of claim 21, wherein the state transfer engine is co-located on the game server.

24. The state transfer engine of claim 21, wherein the state transfer engine is located on a server external to the game server.

25. The state transfer engine of claim 21, wherein the detecting parameters related to the change in the first user's performance comprises monitoring the first user's actions in the interactive gaming environment for one or more predetermined patterns.

26. The state transfer engine of claim 25, wherein the predetermined patterns comprise a crowdsourced input from additional users of the interactive gaming environment.

27. The state transfer engine of claim 21, wherein upon the sending the state information of the first user to the second user, the first user ceases participating in the interactive gaming environment.

28. The state transfer engine of claim 21, wherein upon the sending the state information of the first user to the second user, the first user continues participating in an instanced interactive gaming environment without interruption.

29. The state transfer engine of claim 21, wherein the interactive gaming environment comprises a virtual reality (VR) or augmented reality (AR) environment.

30. The state transfer engine of claim 21, wherein the processor is further configured to send state information of the second user to the first user upon the second user advancing within the interactive gaming environment based on the state information of the first user.
